(19) United States
(12) Patent Application Publication
(10) Pub. No.: US 2022/0049817 A1
(43) Pub. Date: Feb. 17, 2022

(54) GAS ADSORPTION/DESORPTION DEVICE, OBJECT SECURING DEVICE, DRONE, PRESSURE CONTROL METHOD, AND OBJECT GRIPPING METHOD

(71) Applicant: Panasonic Intellectual Property Management Co., Ltd., Osaka (JP)

(72) Inventors: YUKI OHARA, Osaka (JP); MASASHI MORITA, Tokyo (JP); NAOYA SAKATA, Hyogo (JP); HIDEKAZU ARASE, Hyogo (JP); MASAAKI SUZUKI, Osaka (JP); YOSHIMITSU IKOMA, Nara (JP); MASAHIRO NAKAMURA, Osaka (JP)

(21) Appl. No.: 17/505,072

(22) Filed: Oct. 19, 2021

Related U.S. Application Data
(63) Continuation of application No. PCT/JP2020/006225, filed on Feb. 18, 2020.

(30) Foreign Application Priority Data
May 24, 2019 (JP) 2019-097933
Jan. 31, 2020 (JP) 2020-014683

(51) Int. Cl. F17C 11/00; B25J 15/00

(52) U.S. Cl. CPC F17C 11/00; F17C 2270/0186; F17C 2221/013; B25J 15/0023

(57) ABSTRACT

A gas adsorption/desorption device includes a gastight enclosure filled with a predetermined gas and supplied with no gas from outside or releasing no gas to the outside, and a porous medium disposed in the gastight enclosure. The predetermined gas in the porous medium is released out of the porous medium in response to supply of energy to the porous medium. The porous medium captures the predetermined gas in the gastight enclosure in response to stopping or reducing of the supply of the energy to the porous medium.

### BACKGROUND

### 1. Technical Field

The present disclosure relates to a gas adsorption/desorption device, an apparatus including a gas adsorption/desorption device such as an object securing device or a drone, a pressure control method, and an object gripping method.

### 2. Description of the Related Art

Object gripping devices capable of gripping objects with various shapes are known thus far (for example, Japanese Unexamined Patent Application Publication No. 2018-130810). In recent years, robotic hands using jamming transition have been studied as examples of such object gripping devices.

### SUMMARY

In one general aspect, the techniques disclosed here feature a gas adsorption/desorption device that includes a gastight enclosure filled with a predetermined gas and supplied with no gas from outside or releasing no gas to the outside, and a porous medium disposed in the gastight enclosure. The predetermined gas in the porous medium is released out of the porous medium in response to supply of energy to the porous medium. The porous medium captures the predetermined gas in the gastight enclosure in response to stopping or reducing of the supply of the energy to the porous medium.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a structure of a gas adsorption/desorption device according to an embodiment;

FIG. 2 is a schematic cross-sectional view of another structure of a gas adsorption/desorption device according to an embodiment;

FIG. 3 is a graph of an example of a gas adsorption isotherm for a typical porous medium;

FIG. 4 is a graph of a CO₂ adsorption isotherm for zeolites;

FIG. 5 is a graph of an example of a gas adsorption isotherm for a typical gate-adsorption metal-organic framework (MOF);

FIG. 6 is a graph of a CO₂ adsorption isotherm for ELM-11;

FIG. 7 is a schematic diagram of a structure of a gas adsorption/desorption device used to verify the pressure increase/decrease principle in a porous medium;

FIG. 8 is a graph of an example of an X-ray diffraction pattern of Mg-MOF-74 obtained by synthesis;

FIG. 9 is a graph of an X-ray diffraction pattern of Mg-MOF-74 obtained by synthesis in S. R. Caskey et al., J. Am. Chem Soc., 2008, 130, 10780 (Non-patent Literature 2);

FIG. 10 is a graph showing thermogravimetric (TG) curves for Mg-MOF-74;

FIG. 11 is a schematic diagram of another structure of a gas adsorption/desorption device used to verify the pressure increase/decrease principle in a porous medium;

FIG. 12A is a schematic diagram of a second gastight enclosure of the gas adsorption/desorption device according to another embodiment in a depressurized state;

FIG. 12B is a schematic diagram of a second gastight enclosure of the gas adsorption/desorption device according to another embodiment in a pressurized state;

FIG. 13 is a diagram showing the steps performed when a robotic hand, to which a gas adsorption/desorption device according to another embodiment is applied, grips a workpiece;

FIG. 14 is a perspective view of a drone according to an embodiment;

FIG. 15 is a perspective view of an infant car seat according to an embodiment;

FIG. 16 is a diagram of an assist suit according to an embodiment when worn by a user; and

FIG. 17 is a diagram of an example of a composite including a porous medium and a powder adhesive.

### DETAILED DESCRIPTION

An existing object gripping device using jamming transition includes, for example, a gripper formed from a gastight enclosure such as a flexible hollow bag filled with powder. Such an object gripping device increases or decreases the pressure inside the flexible gastight enclosure filled with powder to harden or soften the gastight enclosure. Thus, the gripper formed from a gastight enclosure can grip or release an object.

The existing object gripping device, however, includes a large-sized device to increase or decrease the pressure inside the gastight enclosure.

The present disclosure provides a gas adsorption/desorption device capable of efficiently increasing or decreasing the pressure with a simple structure, an object securing device including the gas adsorption/desorption device, a drone including the gas adsorption/desorption device, a pressure control method using the gas adsorption/desorption device, and an object gripping method using the gas adsorption/desorption device.

### Underlying Knowledge Forming Basis of the Present Disclosure

Before specifically describing embodiments of the present disclosure, the underlying knowledge forming the basis of an aspect of the present disclosure will be described.

An existing object gripping device increases or decreases the pressure inside a gastight enclosure using a pressurizer/depressurizer.

For example, an existing object gripping device decreases the pressure in the gastight enclosure with a depressurizer such as a vacuum pump. On the other hand, to increase the pressure in the gastight enclosure, for example, a selector valve disposed in a closed system is used to increase the pressure in the closed system from the depressurized state to the atmospheric-pressure state with exposure to the atmosphere, or a compressor is used to increase the pressure.

However, such a pressurizing/depressurizing method using mechanical principles involves a large-sized apparatus such as a vacuum pump and stationary power for driving, and also separately involves a pressurizing mechanism and a depressurizing mechanism. With this method, the pressurizing and depressurizing mechanisms or an object gripping device including the mechanisms may have a large size, a heavy weight, or a complex structure.

On the other hand, to decrease the pressure in the gastight enclosure, it takes time, for a structure without an apparatus such as a vacuum pump, to release gas from the gastight enclosure, and responsivity is lowered. With the method for increasing the pressure in the gastight enclosure with exposure to the atmosphere, it takes time to increase the pressure, and responsivity is lowered.

A porous medium has nanometer-size pores inside to be capable of adsorbing molecules in the pore space.

The present inventors have paid an attention to the gas adsorption capability of this porous medium, and have reached findings that the pressure in a gastight enclosure filled with a porous medium and gas (gas molecules) may be decreased as a result of the porous medium adsorbing gas, and, that, when the pressure in the gastight enclosure is decreased, the pressure may be increased as a result of gas adsorbed by the porous medium being desorbed.

The present inventors have diligently studied based on these findings, and found the use of gas adsorption/desorption with a porous medium for a pressurizing/depressurizing mechanism and a pressurizing/depressurizing method. Specifically, the present inventors have found a pressurizing/depressurizing mechanism and a pressurizing/depressurizing method involving a control of gas adsorption/desorption with a porous medium by supplying energy to the porous medium or stopping or reducing supply of energy to increase or decrease the pressure in the gastight enclosure. The present inventors have actually proved that this control on the change of the pressure in the gastight enclosure is possible.

Specific aspects of the present disclosure will be described, below.

A gas adsorption/desorption device according to an aspect of the present disclosure includes a gastight enclosure filled with a predetermined gas and supplied with no gas from outside or releasing no gas to the outside, and a porous medium disposed in the gastight enclosure. The predetermined gas in the porous medium is released out of the porous medium in response to supply of energy to the porous medium, and the porous medium captures the predetermined gas in the gastight enclosure in response to stopping or reducing of the supply of the energy to the porous medium.

This structure can control gas adsorption/desorption with the porous medium by simply supplying energy to the porous medium, or stopping or reducing supply of energy to the porous medium. This simple structure can thus increase or decrease the pressure inside the gastight enclosure with high responsivity. This structure can thus efficiently control the pressure in the gastight enclosure without using a device such as a vacuum pump. This simple structure can thus achieve size reduction, weight reduction, and independence of the pressurizing/depressurizing mechanism, and can efficiently increase or decrease the pressure.

In a gas adsorption/desorption device according to an aspect of the present disclosure, the gastight enclosure may include a first gastight enclosure and a second gastight enclosure coupled to the first gastight enclosure through an airway, and the porous medium may be disposed inside the first gastight enclosure.

This structure can control a pressure in the second gastight enclosure, serving as a target of pressure change, with gas adsorption/desorption of the porous medium disposed in the first gastight enclosure, different from the second gastight enclosure. Thus, the pressure in the second gastight enclosure can be more efficiently controlled.

In a gas adsorption/desorption device according to an aspect of the present disclosure, energy may be supplied to the porous medium to raise the pressure in the gastight enclosure, and supply of energy to the porous medium may be stopped or energy supplied to the porous medium may be reduced to lower the pressure in the gastight enclosure. A pressure in the gastight enclosure may rise in response to the supply of the energy to the porous medium, and the pressure in the gastight enclosure may lower in response to stopping of the supply of the energy to the porous medium.

This simple structure can increase or decrease the pressure inside the gastight enclosure with high responsivity, and thus can efficiently increase or decrease the pressure.

In a gas adsorption/desorption device according to an aspect of the present disclosure, the porous medium may be a metal-organic framework.

This structure can increase the amount of gas adsorbed by the porous medium, and thus can increase the degree of changes in pressure resulting from gas adsorption/desorption.

In a gas adsorption/desorption device according to an aspect of the present disclosure, the metal-organic framework may be a gate-adsorption metal-organic framework.

This structure can easily and completely desorb gas adsorbed by the porous medium, and thus can increase the efficiency. The amount of adsorption changes suddenly, and thus can improve pressurizing and depressurizing responsivity resulting from desorption and adsorption.

In a gas adsorption/desorption device according to an aspect of the present disclosure, the porous medium may be a composite including at least one selected from the group consisting of an inorganic material, an organic material, and a metal.

This structure can improve the energy transfer rate of the porous medium, and can improve responsivity. This structure can thus further improve the efficiency, and accelerate the pressurizing speed.

In a gas adsorption/desorption device according to an aspect of the present disclosure, the energy may be heat energy.

This structure can increase or decrease the pressure inside the gastight enclosure by heating or cooling the porous medium.

Alternatively, in a gas adsorption/desorption device according to an aspect of the present disclosure, the energy may be light energy.

This simple structure can improve efficiency and pressurizing and depressurizing responsivity.

Alternatively, in a gas adsorption/desorption device according to an aspect of the present disclosure, the energy may be magnetic energy.

This simple structure can improve efficiency and pressurizing and depressurizing responsivity.

An object securing device according to an aspect of the present disclosure includes a securer including any of the gas adsorption/desorption devices, the securer securing a position of an object, and an energy supplier that supplies energy to the porous medium, or stops or reduces supply of energy to the porous medium. When the energy supplier supplies the energy to the porous medium, or stops or reduces the supply of the energy to the porous medium, the pressure in the gastight enclosure in the gas adsorption/desorption device changes to secure the position of the object.

This structure can control gas adsorption/desorption with the porous medium of the gas adsorption/desorption device by simply supplying energy to the porous medium, or stopping or reducing supply of energy to the porous medium. This structure can thus change the pressure in the gastight enclosure with high responsivity to secure the position of an object. This simple structure can thus efficiently control the pressure in the gastight enclosure without using a device such as a vacuum pump, and can efficiently increase or decrease the pressure. Thus, an object securing device including a securer that can efficiently secure the position of the object with a simple structure can be achieved.

A drone according to an aspect of the present disclosure includes an object contact portion that grips an object or releases the object, and a controller that controls the object contact portion to grip or release the object. The object contact portion includes any of the above gas adsorption/desorption devices. In response to a control signal transmitted from the controller, supply of energy to the porous medium is started, stopped, or reduced to change a pressure in the gastight enclosure in the gas adsorption/desorption device.

This structure can control gas adsorption/desorption with the porous medium of the gas adsorption/desorption device by simply supplying energy to the porous medium, or stopping or reducing supply of energy to the porous medium. This structure can thus change the pressure in the gastight enclosure with high responsivity to grip or release the object. This simple structure can thus efficiently control the pressure in the gastight enclosure without using a device such as a vacuum pump, and can efficiently increase or decrease the pressure. Thus, a drone including an object contact portion that can efficiently grip or release an object with a simple structure can be achieved.

The technology of the present disclosure is useful not only as a pressure controlling device including a gas adsorption/desorption device, but also as a pressure control method using a gas adsorption/desorption device.

Specifically, a pressure control method according to an aspect of the present disclosure is a pressure control method using a gastight enclosure and a porous medium, the gastight enclosure being filled with a predetermined gas and being supplied with no gas from outside or releasing no gas to the outside, the porous medium being disposed in the gastight enclosure. The method includes pressurizing the gastight enclosure by releasing the predetermined gas in the porous medium out of the porous medium in response to supply of energy to the porous medium, and depressurizing the gastight enclosure by capturing the predetermined gas in the gastight enclosure with the porous medium in response to stopping or reducing supply of energy to the porous medium.

This structure can control gas adsorption/desorption with the porous medium by simply supplying energy to the porous medium, or stopping or reducing supply of energy to the porous medium. This structure can thus increase or decrease the pressure inside the gastight enclosure with high responsivity. This structure can thus efficiently control the pressure in the gastight enclosure without using a device such as a vacuum pump. This simple structure can thus efficiently increase or decrease the pressure.

In a pressure control method according to an aspect of the present disclosure, the gastight enclosure may include a first gastight enclosure and a second gastight enclosure coupled to the first gastight enclosure, and the porous medium may be disposed in the first gastight enclosure. The second gastight enclosure may be pressurized or depressurized by desorbing the predetermined gas from the porous medium or adsorbing the predetermined gas with the porous medium.

This structure can control the pressure in the second gastight enclosure, serving as a target of pressure change, with gas adsorption/desorption of the porous medium disposed in a first gastight enclosure, which is different from the second gastight enclosure. Thus, the pressure in the second gastight enclosure can be more efficiently controlled.

In a pressure control method according to an aspect of the present disclosure, the second gastight enclosure may be formed from an elastically deformable material.

This structure can elastically deform the second gastight enclosure by pressurizing or depressurizing the second gastight enclosure.

In a pressure control method according to an aspect of the present disclosure, the porous medium may be subjected to treatment to be capable of adsorbing the predetermined gas before being placed in the first gastight enclosure.

This structure allows the porous medium disposed in the first gastight enclosure to adsorb gas by stopping or reducing supply of energy, and thus can depressurize the second gastight enclosure.

In a pressure control method according to an aspect of the present disclosure, the porous medium may be a metal-organic framework.

This structure can increase the amount of gas adsorbed by the porous medium, and thus can increase the degree of changes in pressure resulting from gas adsorption and desorption.

In a pressure control method according to an aspect of the present disclosure, the metal-organic framework may be a gate-adsorption metal-organic framework.

This structure can easily and completely desorb gas adsorbed by the porous medium, and thus can improve efficiency. In addition, the amount of adsorption changes suddenly. Thus, responsivity of increasing and decreasing the pressure accompanied with adsorption and desorption can be improved.

An object gripping method according to an aspect of the present disclosure is an object gripping method performed by using a first gastight enclosure, a porous medium, and a second gastight enclosure, the first gastight enclosure being filled with a predetermined gas and being supplied with no gas from outside or releasing no gas to the outside, the porous medium being disposed in the first gastight enclosure, the second gastight enclosure being coupled to the first gastight enclosure. The method includes softening the second gastight enclosure coupled to the first gastight enclosure by supplying energy to the porous medium to release the predetermined gas in the porous medium out of the porous medium, and hardening the second gastight enclosure by stopping or reducing of supply of the energy to the porous medium to capture the predetermined gas in the second gastight enclosure with the porous medium.

This structure can control gas adsorption/desorption with the porous medium by simply supplying energy to the porous medium, or stopping or reducing supply of energy to the porous medium. This structure can thus increase or decrease the pressure inside the second gastight enclosure with high responsivity. This structure can thus efficiently control the pressure in the second gastight enclosure without using a device such as a vacuum pump. This structure can efficiently increase or decrease the pressure with a simple structure. This simple structure can thus efficiently grip an object with high responsivity.

In an object gripping method according to an aspect of the present disclosure, the second gastight enclosure may be formed from an elastically deformable material.

By thus pressurizing or depressurizing the second gastight enclosure to elastically deform the second gastight enclosure, this structure can easily harden or soften the second gastight enclosure. This simple structure can thus efficiently grip an object.

In an object gripping method according to an aspect of the present disclosure, softening the second gastight enclosure may include blocking flow of gas between the first gastight enclosure and the second gastight enclosure to desorb gas from the porous medium, and thereafter, flowing gas between the first gastight enclosure and the second gastight enclosure to pressurize the second gastight enclosure. Hardening the second gastight enclosure may include blocking flow of gas between the first gastight enclosure and the second gastight enclosure to cause the porous medium to adsorb gas, and thereafter, flowing gas between the first gastight enclosure and the second gastight enclosure to depressurize the second gastight enclosure.

By thus controlling flow of gas between the first gastight enclosure and the second gastight enclosure to control timing of pressurizing and depressurizing the second gastight enclosure, the second gastight enclosure can be softened or hardened.

Embodiments of the present disclosure will now be described below with reference to the drawings. Embodiments described below are general or specific examples of the present disclosure. The numerical values, shapes, materials, components, arrangement of the components, connection between the components, steps, order of steps, and other parameters described in the following embodiments are mere examples and not intended to limit the present disclosure. Among components of the embodiments described below, components not included in the independent claims are described as optional components.

The drawings are schematic and not strict. The scales may vary among the drawings. Throughout the drawings, components having substantially the same functions are denoted with the same reference signs with fewer or no description to avoid redundancy.

### Embodiment

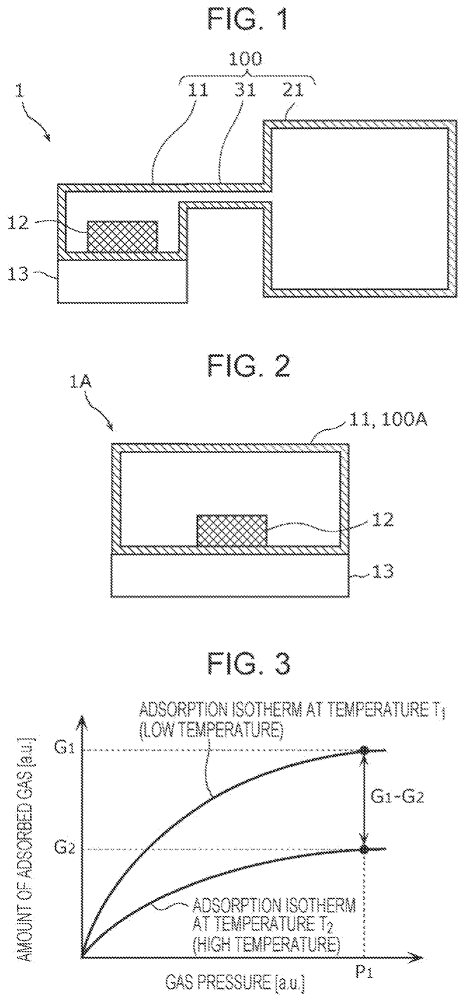

The structure of a gas adsorption/desorption device 1 according to an embodiment will be described with reference to FIG. 1. FIG. 1 is a schematic cross-sectional view of the structure of the gas adsorption/desorption device 1 according to an embodiment.

As illustrated in FIG. 1, the gas adsorption/desorption device 1 includes a porous medium 12 disposed in a gastight enclosure 100 filled with gas, and an energy producer 13 that generates energy supplied to the porous medium 12.

The gastight enclosure 100 is an enclosed container structure forming an enclosed space for accommodating a predetermined gas. Specifically, the gastight enclosure 100 is hermetically sealed, and filled with a predetermined gas without receiving or releasing gas from or to the outside. In the present embodiment, the gastight enclosure 100 includes a first gastight enclosure 11 and a second gastight enclosure 21 coupled to the first gastight enclosure 11 through an airway 31.

In addition to the porous medium 12 and the energy producer 13, the gas adsorption/desorption device 1 also includes the first gastight enclosure 11. In the present embodiment, the gas adsorption/desorption device 1 includes the second gastight enclosure 21 besides the first gastight enclosure 11. Specifically, the gas adsorption/desorption device 1 includes the gastight enclosure 100.

The first gastight enclosure 11 and the second gastight enclosure 21 are hollow housings. The first gastight enclosure 11 and the second gastight enclosure 21 are filled with a predetermined gas. The first gastight enclosure 11 accommodates the porous medium 12. The first gastight enclosure 11 and the second gastight enclosure 21 are formed from metal such as stainless steel. Instead of being formed from metal, the first gastight enclosure 11 and the second gastight enclosure 21 may be formed from resin as long as being hermetically sealed. Instead, the first gastight enclosure 11 and the second gastight enclosure 21 may be elastically deformable hollow bags with rubber elasticity formed from a material such as an elastomer.

Instead of being formed from the same material, the first gastight enclosure 11 and the second gastight enclosure 21 may be formed from different materials. For example, one of the first gastight enclosure 11 and the second gastight enclosure 21 may be a rigid body formed from a material such as metal, and the other may be formed from a deformable material instead of a rigid body. Deformable materials include deformable elastic body with rubber elasticity and a deformable film bag without rubber elasticity. When the first gastight enclosure 11 and the second gastight enclosure 21 are formed from different materials, the first gastight enclosure 11 accommodating the porous medium 12 is preferably formed from a nondeformable rigid body, and the second gastight enclosure 21 not accommodating the porous medium 12 is preferably formed from an elastically deformable material such as an elastic body.

The airway 31 is a tubular member, for example, a metal-made or resin-made pipe. In the present embodiment, the airway 31 constitutes part of the gastight enclosure 100. The airway 31 may be separate from the first gastight enclosure 11 and the second gastight enclosure 21, may be part of the first gastight enclosure 11, or may be part of the second gastight enclosure 21.

The first gastight enclosure 11 and the second gastight enclosure 21 are separated with the airway 31 interposed therebetween. Specifically, the first gastight enclosure 11 and the second gastight enclosure 21 are spatially coupled together with the airway 31. The first gastight enclosure 11, the second gastight enclosure 21, and the airway 31 allow gas to flow forward and backward therethrough, and form a closed system, which is a single enclosed space area. This space area is filled with a specific gas adsorbed by the porous medium 12.

The porous medium 12 has nanometer-size pores, and is capable of adsorbing gas to the pore space. Besides adsorbing gas, the porous medium 12 can also desorb the adsorbed gas. In other words, the porous medium 12 can adsorb and desorb gas. Specifically, in response to supply of energy, the porous medium 12 desorbs gas adsorbed by the porous medium 12, and adsorbs gas with removal of energy supplied to itself.

Gas adsorbed and desorbed by the porous medium 12 is gas molecules, and is adsorbed by the porous medium 12 with interaction between itself and the pore surface of the porous medium 12. In the description, gas molecules adsorbed and desorbed by the porous medium 12 are simply described as “gas”.

In the present embodiment, the porous medium 12 can adsorb and desorb gas in the gastight enclosure 100. Specifically, the porous medium 12 disposed in the first gastight enclosure 11 can adsorb and desorb gas in the first gastight enclosure 11, and can adsorb and desorb gas in the second gastight enclosure 21.

The energy producer 13 supplies energy to the porous medium 12. The energy producer 13 according to the present embodiment is a heat energy source. Specifically, the energy producer 13 is a heating device that generates heat to supply heat energy to the porous medium 12. The energy producer 13 stops supplying heat energy to the porous medium 12 or reduces heat energy supplied to the porous medium 12. For example, the energy producer 13 that generates heat is a heater.

Here, in response to supply of heat energy from the energy producer 13, the porous medium 12 desorbs gas adsorbed by itself. Specifically, in response to the supply of heat energy, the porous medium 12 releases the predetermined gas in the porous medium 12 out of the porous medium 12. On the other hand, the porous medium 12 adsorbs gas when the energy producer 13 removes heat energy supplied to the porous medium 12. Specifically, stopping or reducing the supply of heat energy to the porous medium 12 causes the porous medium 12 to capture the predetermined gas inside the gastight enclosure 100. The energy producer 13 is, for example, disposed outside of the first gastight enclosure 11, but may be disposed inside the first gastight enclosure 11.

To remove heat energy supplied to the porous medium 12, the supply of heat energy to the porous medium 12 may be stopped or reduced. Specifically, when the energy producer 13 is a heater, the supply of heat energy to the porous medium 12 may be stopped by turning off the heater, or heat energy supplied to the porous medium 12 may be reduced by lowering the heating temperature of the heater.

The gas adsorption/desorption device 1 having the above structure has a pressure control mechanism to control the pressure inside the gastight enclosure 100, and functions as a device that increases the pressure inside the gastight enclosure 100. The gas adsorption/desorption device 1 also functions as a depressurizer that decreases the pressure inside the gastight enclosure 100. Specifically, the gas adsorption/desorption device 1 changes the pressure inside the second gastight enclosure 21 through gas adsorption/desorption of the porous medium 12. More specifically, the gas adsorption/desorption device 1 increases or decreases the pressure inside the second gastight enclosure 21 through gas adsorption/desorption of the porous medium 12. For example, the gas adsorption/desorption device 1 decreases the pressure inside the second gastight enclosure 21 to a predetermined negative pressure, or brings the pressure inside the second gastight enclosure 21 back to the atmospheric pressure.

More specifically, the gas adsorption/desorption device 1 increases the pressure inside the second gastight enclosure 21 with supply of gas to the second gastight enclosure 21 through gas desorption of the porous medium 12 disposed inside the first gastight enclosure 11, and decreases the pressure inside the second gastight enclosure 21 by releasing the gas in the second gastight enclosure 21 from the second gastight enclosure 21 while having the porous medium 12 disposed inside the first gastight enclosure 11 adsorbing gas in the first gastight enclosure 11.

In the present embodiment, in the gas adsorption/desorption device 1, the energy producer 13 supplies energy (heat energy in the present embodiment) to the porous medium 12 to desorb gas adsorbed by the porous medium 12. Thus, gas is supplied to the second gastight enclosure 21 to increase the pressure inside the second gastight enclosure 21. Specifically, the first gastight enclosure 11 and the second gastight enclosure 21 are coupled together with the airway 31 while being hermetically sealed, so that gas desorbed from the porous medium 12 in response to the supply of energy to the porous medium 12 moves into the second gastight enclosure 21 through the airway 31. Thus, the pressure inside the second gastight enclosure 21 is increased.

On the other hand, when gas is adsorbed by the porous medium 12 in response to removal of heat energy supplied to the porous medium 12, gas in the second gastight enclosure 21 moves to the first gastight enclosure 11 through the airway 31. Thus, the pressure inside the second gastight enclosure 21 is decreased.

By thus changing the pressure inside the second gastight enclosure 21, the pressurizer/depressurizer 1 can switch the state inside the second gastight enclosure 21 between the depressurized state and the pressurized state. Specifically, the second gastight enclosure 21 is a target of pressure change. The pressure inside the second gastight enclosure 21 is controlled by the porous medium 12 and the energy producer 13. In other words, the porous medium 12 and the energy producer 13 function as a pressure controller that controls the pressure inside the second gastight enclosure 21.

In the present embodiment, when the porous medium 12 adsorbs or desorbs gas, besides the pressure inside the second gastight enclosure 21, the pressure inside the first gastight enclosure 11 also changes. In other words, the pressure inside the entire gastight enclosure 100 changes. Thus, the gas adsorption/desorption device 1 increases or decreases the pressure inside the gastight enclosure 100 through gas adsorption/desorption of the porous medium 12. Specifically, the gas adsorption/desorption device 1 decreases the pressure inside the gastight enclosure 100 as a result of the porous medium 12 adsorbing gas inside the gastight enclosure 100, and increases the pressure inside the gastight enclosure 100 as a result of the energy producer 13 supplying energy to the porous medium 12 to desorb gas adsorbed by the porous medium 12. Thus, the entirety of the gastight enclosure 100 can be a target of pressure change.

As described above, in the gas adsorption/desorption device 1, gas desorption from the porous medium 12 or gas adsorption of the porous medium 12 can increase or decrease the pressure inside the gastight enclosure 100 to change the pressure inside the gastight enclosure 100.

Specifically, supply of heat energy to the porous medium 12 desorbs gas from the porous medium 12. In other words, supply of heat energy to the porous medium 12 releases gas in the porous medium 12 out of the porous medium 12. Thus, the pressure inside the gastight enclosure 100 rises. On the other hand, removal of heat energy supplied to the porous medium 12 causes the porous medium 12 to adsorb gas. In other words, stopping or reducing supply of energy to the porous medium 12 causes the porous medium 12 to capture gas in the gastight enclosure 100. Thus, the pressure inside the gastight enclosure 100 lowers.

In the present embodiment, the first gastight enclosure 11, the airway 31, and the second gastight enclosure 21 form the gastight enclosure 100, but this is not the only possible structure. For example, as in the gas adsorption/desorption device 1A illustrated in FIG. 2, only the first gastight enclosure 11 may form a gastight enclosure 100A. In this case, the target of pressure change for the gas adsorption/desorption device 1A is the first gastight enclosure 11. In other words, the porous medium 12 is disposed inside the target of pressure change in FIG. 2. The gas adsorption/desorption device 1A illustrated in FIG. 2 does not involve separate installation of a pressure controller, and has a simpler structure.

The structure of the gas adsorption/desorption device 1 illustrated in FIG. 1 will be described, below. As described above, the gas adsorption/desorption device 1 according to the present embodiment controls the pressure inside the second gastight enclosure 21 through gas adsorption/desorption of the porous medium 12. Here, the porous medium 12 disposed inside the first gastight enclosure 11 is preferably activated in advance as primary treatment to adsorb gas. In this case, before being placed in the first gastight enclosure 11, the porous medium 12 is preferably treated to adsorb gas in response to removal of energy supplied to itself. In other word, the porous medium 12 subjected to activation treatment in advance is preferably enclosed in the first gastight enclosure 11. Instead of subjecting the porous medium 12 to activation treatment before placing the porous medium 12 in the first gastight enclosure 11, the porous medium 12 before being subjected to activation treatment may be placed in the first gastight enclosure 11 equipped with a valve, and then the first gastight enclosure 11 may be heated and evacuated to subject the porous medium 12 to activation treatment. When a certain amount of a specific gas is introduced into the first gastight enclosure 11 in which the porous medium 12 subjected to activation treatment is placed, the porous medium 12 adsorbs a predetermined amount of gas in accordance with an adsorption isotherm. Thus, the pressure in the second gastight enclosure 21 lowers to a predetermined value.

Here, FIG. 3 illustrates an example of a gas adsorption isotherm of a typical porous medium. As illustrated in FIG. 3, as the gas pressure rises, the amount of gas adsorbed by the porous medium increases. As the temperature rises, the amount of gas adsorbed by the porous medium decreases. As illustrated in FIG. 3, after the porous medium adsorbs a first adsorption amount G₁ of gas at a first temperature T₁ and the gas reaches a first pressure P₁, and the gas is heated to a second temperature T₂ (T₂>T₁). Here, the amount of gas adsorbed by the porous medium decreases to a second adsorption amount G₂. Thus, an amount of gas corresponding to a difference (G₁−G₂) between the first adsorption amount G₁ and the second adsorption amount G₂ can be desorbed from the porous medium.

On the other hand, when supply of heat energy is stopped to stop heating gas, the gas is cooled to lower the temperature. For example, when supply of heat energy is stopped, the temperature falls from the high second temperature T₂ to the low first temperature T₁. Thus, the amount of gas adsorbed by the porous medium rises from the second adsorption amount G₂ to the first adsorption amount G₁. Thus, an amount of gas corresponding to the difference (G₁−G₂) between the first adsorption amount G₁ and the second adsorption amount G₂ can be adsorbed by the porous medium.

As in the present embodiment, also in a case where the porous medium 12 is disposed in a closed system, supply or no supply of heat energy is assumed to cause desorption of gas adsorbed by the porous medium 12 or adsorption of gas with the porous medium 12. The gas adsorption/desorption device 1 according to the present embodiment controls the pressure inside the gastight enclosure 100 in a closed system using the gas adsorption/desorption characteristics of the porous medium 12.

Here, in the present embodiment, gas desorption with heating and gas adsorption with cooling are controlled by the energy producer 13, which is a heating device such as a heater. For example, the energy producer 13, which is a heater, is installed while being in contact with a portion of the first gastight enclosure 11 where the porous medium 12 is disposed or a portion of the first gastight enclosure 11 filled with the porous medium 12. To increase the pressure, the heater is turned on to heat the porous medium 12. To decrease the pressure, the heater is turned off to naturally cool the porous medium 12. When the cooling speed of natural cooling is low, a device such as a Peltier device or a coolant circulation device may be separately installed as a cooling device. The structure of the heating device or the cooling device is not limited to a particular one as long as it can control the temperature within the range that allows the porous medium to adsorb or desorb an amount of gas required for a predetermined pressure change. The heating and cooling temperatures may be determined as appropriate in accordance with, for example, the type of the porous medium 12, the capacity of a target of pressure change, and the usable pressure range of the target of pressure change.

The above pressurizing/depressurizing method enables pressurizing and depressurizing without using an apparatus such as a vacuum pump, and enables size or weight loss of a gas adsorption/desorption device, and independence of the gas adsorption/desorption device. In other words, a pressurizing/depressurizing method based on existing mechanical principles requires a large-sized device, stationary power for driving, and separate installation of a pressurizing mechanism and a depressurizing mechanism. In contrast, the gas adsorption/desorption devices 1 and 1A according to the present embodiments can efficiently increase or decrease the pressure with a simple structure.

The type of a predetermined gas adsorbed or desorbed by the porous medium 12 is not limited to a particular one. However, from the viewpoints of safety and cost, a gas among practical gases that is the most adsorbable by the porous medium 12 at or around the normal temperature and the normal pressure is preferable. The use of such a gas eliminates the mechanism for keeping gas at a low temperature, and can reduce the amount of the porous medium 12 required for a predetermined pressure change. From the above viewpoints, a conceivable example of a gas adsorbed and desorbed by the porous medium 12 is carbon dioxide (CO₂).

Here, specific examples of the porous medium 12 included in the gas adsorption/desorption device 1 will be described in detail. The porous medium 12 is a porous object having a large number of pores. For example, the porous medium 12 is in a powder form, but may be in any form.

As described above, gas is adsorbed by the porous medium 12 or adsorbed gas is desorbed from the porous medium 12. Examples of the porous medium 12 include organic porous media such as active carbon, carbon fiber, carbon nanotube, or resin, inorganic porous media such as zeolites, mesoporous silica, or mesoporous alumina, and other porous media such as a metal-organic framework (MOF) or porous coordination polymer (PCP). The porous medium 12 may be formed from one of these porous media or a composite formed from a combination of some of these porous media. Specifically, the porous medium 12 may be a composite including at least one of organic, inorganic, and metal porous media.

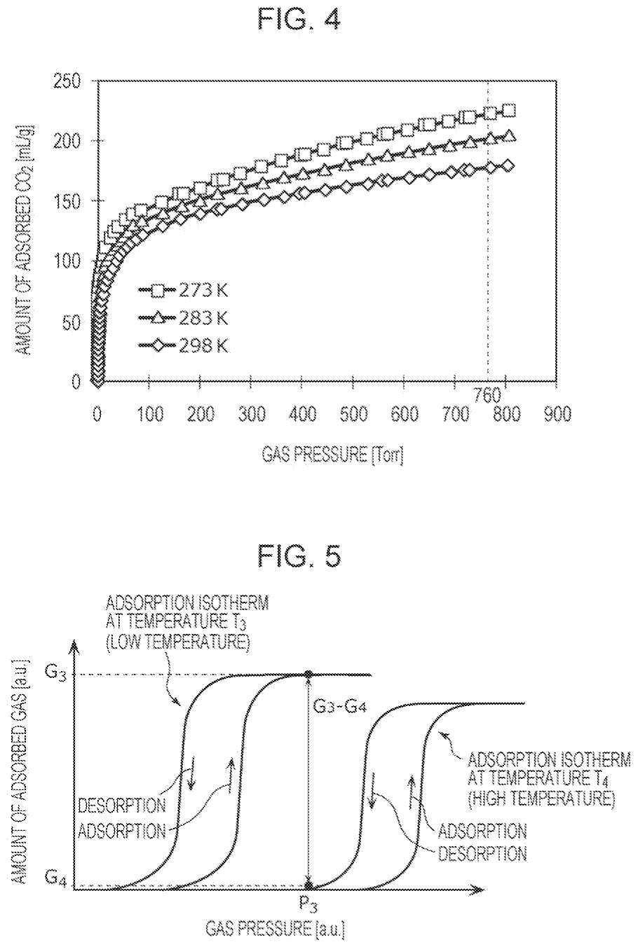

For example, CO₂ adsorption/desorption of a zeolite, used as an example of the porous medium 12, will be described with reference to FIG. 4. FIG. 4 illustrates a CO₂ adsorption isotherm for a zeolite. As illustrated in FIG. 4, when the gas pressure rises, the adsorption amount of CO₂ adsorbed by the zeolite increases. When the temperature rises, the adsorption amount of CO₂ adsorbed by the zeolite decreases. Thus, heating or cooling a zeolite allows the zeolite to adsorb CO₂ or to desorb CO₂ from the zeolite.

The type of the porous medium 12 is not limited to a particular one, and may be selected as appropriate from the above porous media in accordance with the gas adsorbed and desorbed by the porous medium 12, the capacity of the gastight enclosure 100 or the second gastight enclosure 21 (that is, target of pressure change), the range of pressure change, and the adsorption amount appropriate for the porous medium 12. From the viewpoints of the amount of adsorption and responsivity, the porous medium 12 may be a metal-organic framework (hereinafter referred to as a “MOF”) or a porous coordination polymer.

When a MOF is used as an example of the porous medium 12, a specific form of the MOF is not limited to a particular one. However, preferably, a MOF that adsorbs a large amount of a specific gas adsorbable or desorbable by the porous medium 12 at or around the normal temperature is used. Alternatively, a MOF that significantly reduces the amount of adsorption when the temperature rises from the normal temperature may be used. Thus, the temperature for gas desorption can be lowered, so that the consumed heat energy can be reduced. This reduces the time taken for heating and cooling, so that the response speed for gas adsorption/desorption can be increased. In other words, response time for gas adsorption/desorption can be shortened.

The porous medium 12 may be a gate-adsorption metal-organic framework (hereinafter referred to as “a gate-adsorption MOF”). Gate adsorption is a phenomenon in which the amount of gas adsorption changes suddenly, and a gate-adsorption MOF exhibits a special adsorption isotherm unclassifiable by six types of adsorption isotherm defined by International Union of Pure and Applied Chemistry (IUPAC).

Here, FIG. 5 illustrates an adsorption isotherm for a typical gate-adsorption MOF. As illustrated in FIG. 5, when gas has a low pressure, the gate-adsorption MOF scarcely adsorbs gas. When the gas pressure arrives at a predetermined value (the pressure at this time is called a gate opening pressure), the structure of the gate-adsorption MOF changes (for example, layers are shifted from each other or interlayer spacing is widened), so that the gate-adsorption MOF captures gas. At the arrival at the gate opening pressure, the amount of gas adsorption increases suddenly. For gas desorption, on the other hand, when the gas pressure lowers to or below the gate opening pressure, gas captured by the gate-adsorption MOF is released so that the gate-adsorption MOF attempts restoring to the original structure. Thus, gas is suddenly desorbed from the gate-adsorption MOF. For a typical gate-adsorption MOF, as illustrated in FIG. 5, a pressure isotherm at adsorption and an adsorption isotherm at desorption have hysteresis loops, and the gate opening pressure at adsorption is higher than the gate opening pressure at desorption. For the gate-adsorption MOF, the gate opening pressure shifts higher as the temperature rises.

Such a gate adsorption phenomenon is based on the flexibility of the MOF structure, and characteristic of the MOF. Thus, existing porous media having no flexibility do not cause a gate adsorption phenomenon.

As illustrated in FIG. 5, assume a case where a gate-adsorption MOF having such characteristics adsorbs a third adsorption amount G₃ of gas at a third temperature T₃, and the gas reaches a third pressure P₃. When, from this state, gas is heated to a fourth temperature T₄ (T₄>T₃) at which the gate opening pressure at desorption is equal to or higher than a third pressure P₃, the amount of adsorption of the gate-adsorption MOF is a fourth adsorption amount G₄ based on the adsorption isotherm at desorption, so that gas can be desorbed from the gate-adsorption MOF by a difference (G₃−G₄) between the third adsorption amount G₃ and the fourth adsorption amount G₄.

When, on the other hand, gas is cooled to reduce the temperature from the high fourth temperature T₄ to the low third temperature T₃, the amount of gas adsorbed by the gate-adsorption MOF rises from the fourth adsorption amount G₄ to the third adsorption amount G₃. Thus, gas can be adsorbed by the gate-adsorption MOF by a difference (G₃−G₄) between the third adsorption amount G₃ and the fourth adsorption amount G₄.

A gate-adsorption MOF that exhibits an adsorption behavior illustrated in FIG. 5 efficiently adsorbs or desorbs gas compared to a porous medium that exhibits a typical adsorption behavior illustrated in FIG. 3. Specifically, the gate-adsorption MOF has shorter response time for gas adsorption/desorption.

Specifically, in a porous medium that exhibits a typical adsorption behavior illustrated in FIG. 3, the amount of desorbed gas (G₁−G₂) is smaller than the first adsorption amount G₁ of gas adsorbed by the porous medium. Here, to completely desorb gas or to make G₂=0, the gas usually has to be heated to a high temperature. In contrast, when a gate-adsorption MOF illustrated in FIG. 5 is used, the amount (G₃−G₄) of desorbed gas can be regarded as G₄=0. Thus, all the third adsorption amount G₃ of gas adsorbed by the gate-adsorption MOF can be desorbed from the gate-adsorption MOF. For the gate-adsorption MOF, the amount of adsorption changes suddenly, so that responsivity at adsorption and desorption can be improved.

A specific form of the gate-adsorption MOF is not limited to a particular one, but a preferable form is a gate-adsorption MOF that adsorbs a large amount of a specific gas adsorbable and desorbable by the gate-adsorption MOF at or around the normal temperature. In addition, the gate-adsorption MOF preferably has a gate opening pressure that suddenly shifts higher when the temperature rises from the normal temperature. The gate-adsorption MOF can thus reduce the temperature of the gas at desorption and reduce required heat energy. The gate-adsorption MOF also reduces time taken for heating and cooling, and thus can increase the response speed on gas adsorption/desorption.

Examples of a gate-adsorption MOF preferably usable when gas adsorbed and desorbed by the porous medium 12 is carbon dioxide include elastic layer-structured metal organic frameworks (ELMs) such as ELM-11 (H. Kanoh et al., J. Colloid. Interface Sci., 2009, 334, 1, or Non-patent Literature 1). ELM-11 is expressed in a chemical formula of Cu(bpy)₂(BF₄)₂. When the amount of CO₂ adsorbed by ELM-11 is measured, the amount of CO₂ adsorption (difference in amount of CO₂ adsorption between the conditions at the atmospheric pressure at 30° C. and the conditions at the atmospheric pressure at 150° C.) was 2.2 wt %.

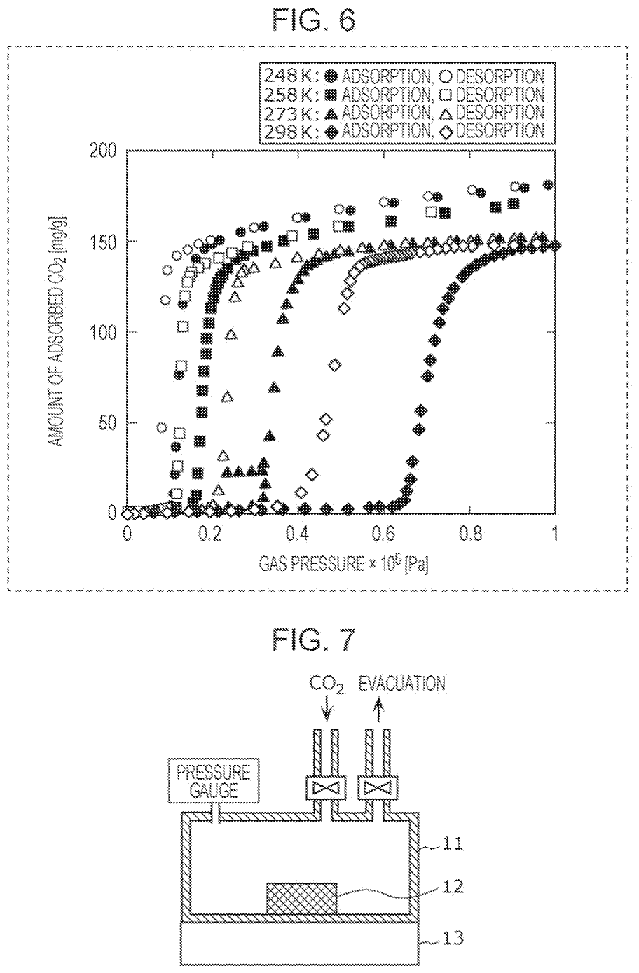

FIG. 6 illustrates a CO₂ adsorption isotherm for ELM-11. As illustrated in FIG. 6, ELM-11 exhibits gate adsorption characteristics and has a gate opening pressure in accordance with the temperature. For ELM-11, a pressure isotherm at adsorption and an adsorption isotherm at desorption do not have hysteresis loops, and the gate opening pressure at adsorption and the gate opening pressure at desorption coincide with each other.

As indicated with the adsorption isotherm illustrated in FIG. 4, the zeolite described above is less likely to be affected by the pressure, and gradually adsorbs or desorbs gas with a change in temperature. As illustrated in FIG. 6, ELM-11, in contrast, is more likely to be affected by the pressure, and suddenly adsorbs or desorbs gas with changes in temperature.

Subsequently, results of experiments conducted to verify the principle of pressure increase/decrease with the porous medium 12 will be described with reference to FIG. 7. FIG. 7 is a schematic diagram of a structure of a gas adsorption/desorption device used to verify the principle of pressure increase/decrease with the porous medium 12.

As illustrated in FIG. 7, the present experiments were conducted using the gas adsorption/desorption device 1A illustrated in FIG. 2, a metal container with a capacity of 2 L as an example of the first gastight enclosure 11, and a heater as an example of the energy producer 13. Mg-MOF-74 expressed in a chemical formular of Mg₂(dobdc), where dobdc denotes 2,5-dihydroxyterephthalic acid, is used as an example of the porous medium 12 to conduct the following experiments. Mg-MOF-74 exhibits an adsorption isotherm with respect to CO₂, similar to that of the zeolite illustrated in FIG. 4.

Before the experiments, Mg-MOF-74 was formed by solvothermal synthesis in the following synthesis method. Synthesis is not limited to the following method, and any of other synthesis methods may be used to form a porous medium having an intended structure.

Specifically, a raw-material solution was prepared by mixing 623 mg of magnesium nitrate hexahydrate (made by FUJIFILM Wako Pure Chemical Corporation), 150 mg of 2,5-dihydroxyterephthalic acid (made by Sigma-Aldrich Corp.), 60 mL of N,N-dimethylformamide (made by FUJIFILM Wako Pure Chemical Corporation), 4 mL of ethanol (made by FUJIFILM Wako Pure Chemical Corporation), and 4 mL of distilled water. This raw-material solution was poured into a 100-mL Teflon (registered trademark) vial, and heated at 125° C. for 24 hours. The obtained sample underwent solid-liquid separation, and then was washed three times with methanol (made by FUJIFILM Wako Pure Chemical Corporation). The washed sample was placed in a 50-mL polypropylene vial, 30 mL of methanol (made by FUJIFILM Wako Pure Chemical Corporation) was added, and the resultant was left still for 24 hours at the normal temperature. Then, the supernatant fluid was removed for replacement of the left solvent. This replacement was repeated four times, and the resultant underwent depressurizing and drying. Mg-MOF-74 can thus be produced.

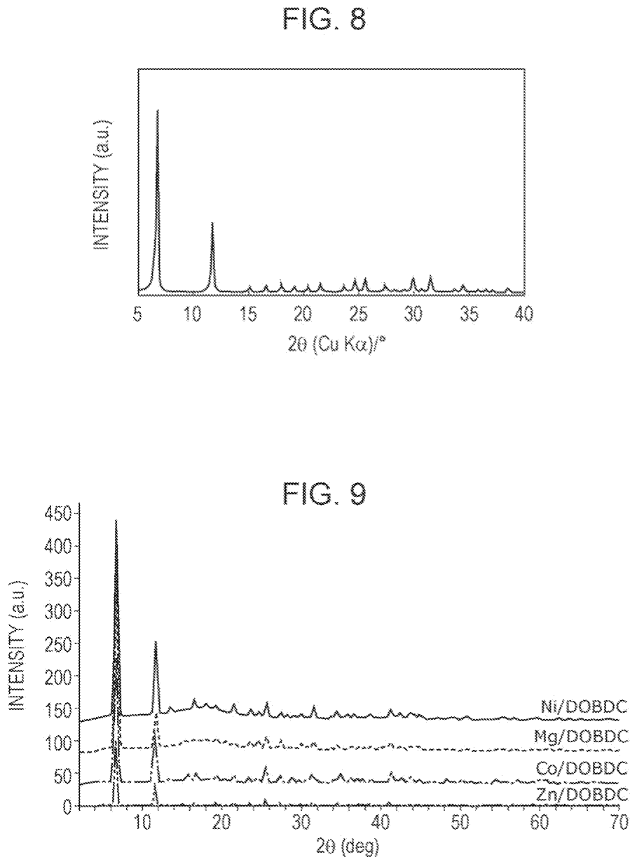

The Mg-MOF-74 sample thus obtained was subjected to X-ray diffractometry using Cu Kα as an X-ray source. Thus, an X-ray diffraction pattern illustrated in FIG. 8 was observed. FIG. 8 illustrates an example of an X-ray diffraction pattern of Mg-MOF-74 resulting from synthesis. In FIG. 8, the vertical axis indicates diffraction intensity, and the horizontal axis indicates a diffraction angle (2θ). FIG. 9 illustrates an X-ray diffraction pattern of Mg-MOF-74 resulting from synthesis in Non-patent Literature 2. Mg/DOBDC in FIG. 9 is a compound equivalent to Mg-MOF-74 in the present disclosure.

As illustrated in FIG. 8 and FIG. 9, the X-ray diffraction pattern of synthetized Mg-MOF-74 sample substantially coincides with an X-ray diffraction pattern of Mg/DOBDC (Mg-MOF-74) synthesized in Non-patent Literature 2. This has proved that Mg-MOF-74 is produced by synthesis.

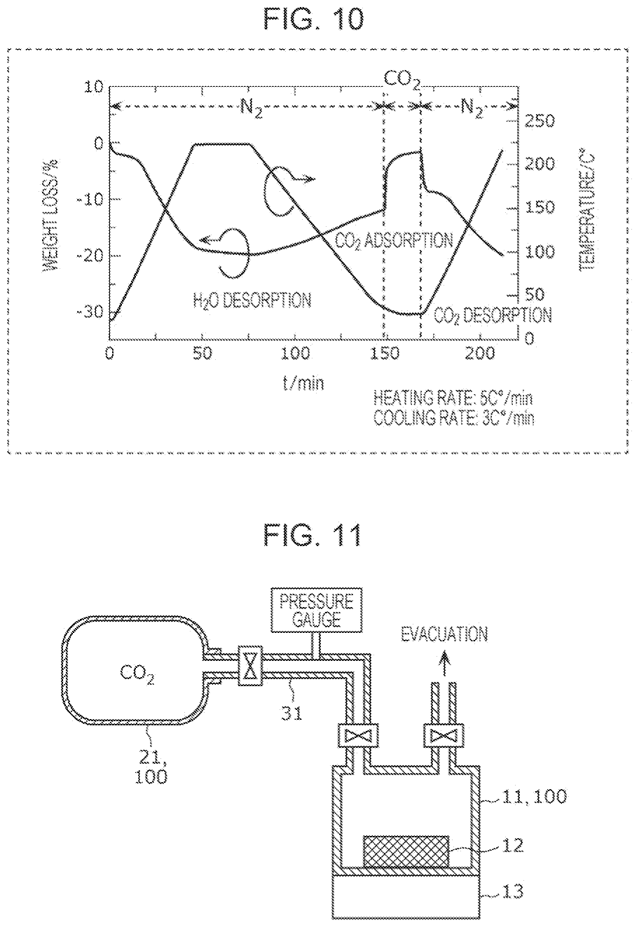

Subsequently, the adsorption speed of Mg-MOF-74 was evaluated. Specifically, Mg-MOF-74 subjected to activation treatment was set, and heated to a predetermined temperature under N₂ gas flow (50 mL·min⁻¹). Then, moisture or the like adsorbed at weighing was removed. Thereafter, the temperature was lowered to or around the room temperature, and then the gas flow was switched from N₂ to CO₂ (50 mL·min⁻¹) to cause Mg-MOF-74 to adsorb CO₂. After the weight gain was saturated, the gas flow was switched to N₂ gas again, and then heated and desorbed. As a result, a weight change profile illustrated in FIG. 10 was observed. In FIG. 10, the vertical axis indicates the rate (%) of the weight loss of Mg-MOF-74, and the horizontal axis indicates time (t). It was confirmed that, when the gas flow was switched to CO₂ flow, the weight suddenly increases on a second scale accompanied with CO₂ adsorption of Mg-MOF-74. The amount of CO₂ adsorption was calculated as 19 wt % with reference to the weight after pretreatment.

Using Mg-MOF-74 thus synthesized and subjected to adsorption speed evaluation, the experiments to verify the pressure increase/decrease principle of the porous medium 12 were conducted in the following manner.

First, Mg-MOF-74 subjected to activation treatment was quickly weighed in the air, and 1.67 g of Mg-MOF-74 was placed in the first gastight enclosure 11. Then, a heater was installed at the bottom of the first gastight enclosure 11, and the first gastight enclosure 11 was heated and evacuated at 150° C. for three hours as pretreatment to change the pressure inside the first gastight enclosure 11 to −0.1 MPa.

Thereafter, evacuation was stopped, and carbon dioxide gas was introduced into the first gastight enclosure 11 until the pressure inside the first gastight enclosure 11 was changed to −0.010 MPa while the heating state was kept.

Subsequently, the heater was turned off, and the porous medium 12 started being cooled by natural cooling. Then, the pressure inside the first gastight enclosure 11 was stabilized in 10 minutes, and the pressure inside the first gastight enclosure 11 was changed to −0.032 MPa.

Thus cooling Mg-MOF-74 placed in the first gastight enclosure 11 decreases the pressure in the first gastight enclosure 11 from −0.010 MPa before cooling to −0.032 MPa after cooling. This is probably because the pressure inside the first gastight enclosure 11 is decreased by the porous medium 12 adsorbing carbon dioxide gas.

The similar experiments were conducted without placing the porous medium 12 in the first gastight enclosure 11. Here, the pressure in the first gastight enclosure 11 before cooling was −0.010 MPa, and the pressure in the first gastight enclosure 11 after cooling was −0.024 MPa. The reason why the pressure has a difference of 0.014 before and after cooling regardless of the absence of the porous medium 12 is assumed to be because of the thermal contraction (equation of state of gas) due to cooling of the gas itself in the first gastight enclosure 11. Thus, the amount of gas adsorbed by the porous medium 12 is calculated from the pressure difference between the pressure in the first gastight enclosure 11 (−0.032 MPa) after cooling using the porous medium 12 and the pressure in the first gastight enclosure 11 after cooling without using the porous medium 12.

From the results of the above experiments, it has been confirmed that cooling the porous medium 12 placed in the closed-system first gastight enclosure 11 changes the pressure inside the first gastight enclosure 11.

The amount of carbon dioxide gas adsorbed by Mg-MOF-74 is calculated as 17 wt % based on the pressure difference between the pressure (−0.032) in the first gastight enclosure 11 after cooling using Mg-MOF-74 and the pressure (−0.024) in the first gastight enclosure 11 after cooling without using Mg-MOF-74. Specifically, Mg-MOF-74 can adsorb 0.17 g of carbon dioxide gas per gram.

This result substantially coincides with the amount of CO₂ adsorption on the known thermogravimetry (TG) curve of Mg-MOF-74 illustrated in FIG. 10.

A similar experiment was conducted using 8.10 g of ELM-11, instead of Mg-MOF-74, as the porous medium 12.

As a result, the pressure inside the first gastight enclosure 11 was changed from −0.010 MPa before cooling to −0.034 MPa after cooling.

Also in the case of using ELM-11 as the porous medium 12, it was confirmed that the pressure inside the first gastight enclosure 11 is changed by cooling the porous medium 12 placed in the closed-system first gastight enclosure 11.

The amount of carbon dioxide gas adsorbed by ELM-11 is calculated as 2 wt % based on the pressure difference between the pressure (−0.028) in the first gastight enclosure 11 after cooling using ELM-11 and the pressure (−0.024) in the first gastight enclosure 11 after cooling without using ELM-11. Specifically, ELM-11 can adsorb 0.02 g of carbon dioxide gas per gram.

Subsequently, results of experiments conducted to verify the pressure increase/decrease principle of the porous medium 12 for the gas adsorption/desorption device 1 illustrated in FIG. 1 will be described with reference to FIG. 11. FIG. 11 is a schematic diagram of another structure of a gas adsorption/desorption device used to verify the pressure increase/decrease principle of the porous medium 12.

In the present experiments, a metal container with a capacity of 50 mL was used as an example of the first gastight enclosure 11, and a Tetra Pak container with a capacity of approximately 3 L with rubber elasticity was used as an example of the second gastight enclosure 21. The first gastight enclosure 11 and the second gastight enclosure 21 are coupled together with an airway 31, which is a metal pipe at which a pressure gauge and multiple valves are installed. Mg-MOF-74 was used as an example of the porous medium 12, and a heater and a cool stirrer were used as examples of the energy producer 13.

First, Mg-MOF-74 subjected to activation treatment was quickly weighed in the air, and 2.8 g of Mg-MOF-74 was placed in the first gastight enclosure 11. Then, the second gastight enclosure 21 filled with carbon dioxide gas and a vacuum pump were coupled to the first gastight enclosure 11, the heater was installed at the bottom of the first gastight enclosure 11 for heating, and the first gastight enclosure 11 was heated and evacuated at 200° C. for three hours as pretreatment to change the pressure inside the first gastight enclosure 11 to −0.1 MPa.

Thereafter, evacuation was stopped, the second gastight enclosure 21 was opened while the heating state was kept, and carbon dioxide gas was introduced until the pressure inside the closed system was changed to 0.10 MPa. Here, the second gastight enclosure 21 was fully filled with carbon dioxide gas.

Thereafter, the heater was replaced with the cool stirrer to start cooling the porous medium 12. Then, the second gastight enclosure 21 contracted in three minutes. Specifically, it is assumed that the pressure inside the second gastight enclosure 21 is decreased by carbon dioxide gas adsorption of the porous medium 12.

Subsequently, the cool stirrer was replaced with the heater, and the porous medium 12 was heated again. Then, the second gastight enclosure 21 expanded in three minutes. Specifically, it is assumed that carbon dioxide gas is desorbed from the porous medium 12 and the pressure inside the second gastight enclosure 21 is increased.

When similar experiments were conducted without using the porous medium 12, neither contraction nor expansion of the second gastight enclosure 21 were observed.

The above results of experiments have revealed that the porous medium 12 that has adsorbed gas desorbs gas by heating, and adsorbs gas again by cooling to increase and decrease the pressure in the second gastight enclosure 21.

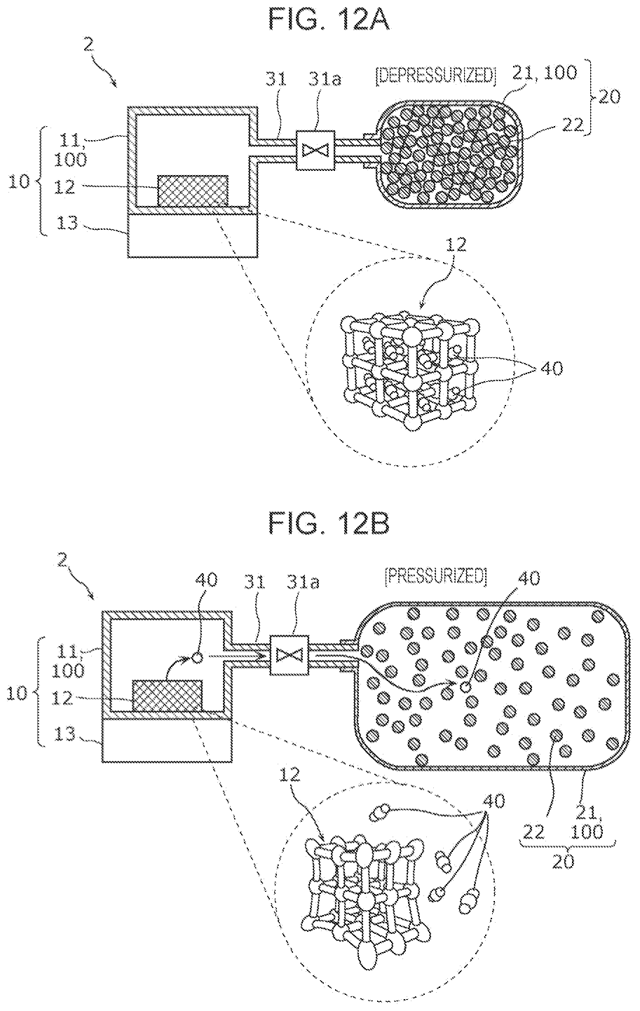

Subsequently, a gas adsorption/desorption device 2 according to another embodiment will be described with reference to FIGS. 12A and 12B. FIG. 12A is a schematic diagram of a gas adsorption/desorption device 2 according to another embodiment where the pressure inside the second gastight enclosure 21 is low. FIG. 12B is a schematic diagram of the gas adsorption/desorption device 2 where the pressure inside the second gastight enclosure 21 is high.

First, the structure of the gas adsorption/desorption device 2 illustrated in FIGS. 12A and 12B will be described.

The gas adsorption/desorption device 2 illustrated in FIGS. 12A and 12B is a second gas adsorption/desorption device. Unlike the adsorption/desorption device 1, which is a first gas adsorption/desorption device illustrated in FIG. 1, the second gastight enclosure 21 is filled with granules 22.

The gas adsorption/desorption device 2 according to the present embodiment is used as an object gripping device capable of gripping objects with various shapes using jamming transition. As illustrated in FIGS. 12A and 12B, the gas adsorption/desorption device 2 includes a pressurizer/depressurizer 10 and a gripping device 20 that is deformable to grip an object.

The pressurizer/depressurizer 10 is a pressure controlling device that controls the pressure inside the gastight enclosure 100. Specifically, the pressurizer/depressurizer 10 increases or decreases the pressure inside the gastight enclosure 100. In the present embodiment, the pressurizer/depressurizer 10 controls the pressure inside the gripping device 20. Thus, the gripping device 20 is a target of pressure change, whose pressure is changed by the pressurizer/depressurizer 10.

The pressurizer/depressurizer 10 includes a first gastight enclosure 11, a porous medium 12 placed in the first gastight enclosure 11, and an energy producer 13 that supplies energy to the porous medium 12. The entirety of the gas adsorption/desorption device 2 may function as a pressurizer/depressurizer.

The gripping device 20 includes, as the second gastight enclosure 21, a flexible and airtight bag accommodating a substance that changes its state through jamming transition. The gripping device 20 includes granules 22 as a substance that changes its state through jamming transition. The granules 22 are filled in the second gastight enclosure 21. Specifically, the second gastight enclosure 21 is filled with a large number of granules 22. The gripping device 20 is softened or hardened with the granules 22 filled in the second gastight enclosure 21 changing their state through jamming transition between a solid behavior or a fluid behavior. When softened, the second gastight enclosure 21 is in a deformable, soft state, and when hardened, the second gastight enclosure 21 is in a less deformable, hard state.

In the present embodiment, the second gastight enclosure 21 is a hollow bag, and serves as a portion of the gripping device 20 that grips an object. Specifically, when coming into contact with an object, the second gastight enclosure 21 changes its shape following the shape of the object that it grips. Thus, the second gastight enclosure 21 is preferably formed from an elastically deformable material. For example, the second gastight enclosure 21 is preferably an elastically deformable bag with rubber elasticity formed from an elastomer or another object. On the other hand, the first gastight enclosure 11 is formed from a solid body without rubber elasticity. For example, the first gastight enclosure 11 is formed from a material that is not elastically deformable. Specifically, the first gastight enclosure is formed from a metal material or a hard resin material.

The second gastight enclosure 21 may not be elastically deformable as long as it is an enclosed system that reversibly deforms with external force. For example, to avoid leakage of gas from the second gastight enclosure 21, the second gastight enclosure 21 may be formed from a material with high barrier characteristics, or may have its surface coated with a gas barrier film such as silica coat.

For example, the granules 22 filled in the second gastight enclosure 21 may have an easily flowable shape to change its shape to follow the shape of the object that it grips. Thus, the granules 22 preferably have a spherical shape. The granules 22 may have an undulating shape or a polyhedral shape. The granules 22 are, for example, powder or particles formed from an inorganic, organic, or metal material. Examples of the granules 22 include resin beads formed from resin such as polystyrene used for styrene foam and glass beads formed from a glass material. The material of the granules 22 is not limited to this, and may be any material that can exert jamming transition when being filled in the second gastight enclosure 21.

The pressurizer/depressurizer 10 controls the pressure inside the second gastight enclosure 21. Specifically, the pressurizer/depressurizer 10 decreases the pressure inside the second gastight enclosure 21 by releasing gas in the second gastight enclosure 21 from the second gastight enclosure 21, and increases the pressure inside the second gastight enclosure 21 by supplying gas into the second gastight enclosure 21. In the present embodiment, the pressurizer/depressurizer 10 decreases the pressure inside the second gastight enclosure 21 to a predetermined negative pressure, or brings the pressure inside the second gastight enclosure 21 back to the atmospheric pressure. The pressurizer/depressurizer 10 can switch the gripping device 20 between the softened state and hardened state by changing the pressure inside the second gastight enclosure 21.

In the present embodiment, a heater is used as an example of the energy producer 13. The closed system constituted of the first gastight enclosure 11, the second gastight enclosure 21, and the airway 31 hermetically seals off CO₂ as the gas 40. The gas adsorption/desorption device 2 is installed under the normal temperature.

A controlling device 31a that controls a gas flow that passes through the airway 31 is installed at the airway 31. The controlling device 31a controls, for example, opening/closing of the airway 31 or the flow rate of gas passing through the airway 31. The controlling device 31a is a cock such as a selector valve.

The controlling device 31a installed at the airway 31 can control the flow of gas adsorbed and desorbed by the porous medium 12 of the pressurizer/depressurizer 10. Thus, the pressure inside the second gastight enclosure 21 can be easily adjusted, and the degree of freedom of adjustment of the pressure inside the second gastight enclosure 21 is improved. Specifically, when the controlling device 31a is a cock, the porous medium 12 is heated to desorb gas in advance while the cock is closed, and then the cock is opened to flow gas into the second gastight enclosure 21 to increase the pressure inside the second gastight enclosure 21. Specifically, controlling opening and closing of the cock enables controlling of timing at which the second gastight enclosure 21 is pressurized or depressurized.

For example, the cock is closed to block the gas flow between the first gastight enclosure 11 and the second gastight enclosure 21 to desorb the gas from the porous medium 12. Thereafter, the cock is opened to flow the gas between the first gastight enclosure 11 and the second gastight enclosure 21 to pressurize the second gastight enclosure 21 and soften the second gastight enclosure 21. The cock is closed again to block the gas flow between the first gastight enclosure 11 and the second gastight enclosure 21 to cause the porous medium 12 to adsorb the gas. Thereafter, the cock is opened to flow the gas between the first gastight enclosure 11 and the second gastight enclosure 21 to depressurize the second gastight enclosure 21 and harden the second gastight enclosure 21.

Subsequently, the operation of the gas adsorption/desorption device 2 illustrated in FIGS. 12A and 12B will be described.

In the state illustrated in FIG. 12A, the heater is turned off, and the porous medium 12 is supplied with no heat energy. In the state illustrated in FIG. 12A, the pressure inside the second gastight enclosure 21 is lower than the atmospheric pressure, and the second gastight enclosure 21 is not yet elastically deformed. The granules 22 filled in the second gastight enclosure 21 crowd together in the second gastight enclosure 21 and exhibit a solid behavior.

In the initial state, the porous medium 12 has undergone activation treatment, and a predetermined amount of CO₂ serving as gas 40 is adsorbed by pores of the porous medium 12. In the state illustrated in FIG. 12A, the gas 40 is adsorbed by the porous medium 12.

When the heater is turned on in the state illustrated in FIG. 12A to supply heat energy to the porous medium 12, as illustrated in FIG. 12B, the structure of the porous medium 12 is deformed to desorb the gas 40 adsorbed by the porous medium 12. Specifically, the gas 40 adsorbed by the porous medium 12 is released from the porous medium 12. The gas 40 desorbed from the porous medium 12 moves into the second gastight enclosure 21 through the airway 31. Thus, the gas 40 that has flowed in increases the pressure inside the second gastight enclosure 21, so that the second gastight enclosure 21 expands. Here, in the present embodiment, the pressure inside the second gastight enclosure 21 is the atmospheric pressure. As a result, the granules 22 in the second gastight enclosure 21 are dispersed inside the second gastight enclosure 21 to exhibit a fluid behavior, and the second gastight enclosure 21 is softened. Here, when receiving external force, the second gastight enclosure 21 is elastically deformed.

When the heater is turned off in the state illustrated in FIG. 12B to stop supplying heat energy to the porous medium 12, the porous medium 12 is cooled by natural cooling, the temperature of the porous medium 12 lowers, and the gas 40 is adsorbed by the porous medium 12. Here, the gas 40 in the second gastight enclosure 21 moves into the first gastight enclosure 11 through the airway 31, and the gas 40 is adsorbed by the porous medium 12. Thus, flowing out of the gas 40 decreases the pressure inside the second gastight enclosure 21. Here, in the present embodiment, the pressure inside the second gastight enclosure 21 is reduced to the predetermined negative pressure. With the elastic resilience of the second gastight enclosure 21, the second gastight enclosure 21 is restored to the original shape. Specifically, the second gastight enclosure 21 is restored to the state illustrated in FIG. 12A. Here, the granules 22 in the second gastight enclosure 21 crowd together in the second gastight enclosure 21 to exhibit a solid behavior, and the second gastight enclosure 21 is hardened. When receiving external force while being hardened, the second gastight enclosure 21 fails to be elastically deformed.

When the heater is turned on again from the state illustrated in FIG. 12A to supply heat energy to the porous medium 12, the state is returned to the state illustrated in FIG. 12B. Specifically, the gas 40 adsorbed by the porous medium 12 is desorbed and moves into the second gastight enclosure 21, and flowing in of the gas 40 increases the pressure inside the second gastight enclosure 21. Specifically, the pressure inside the second gastight enclosure 21 is returned to the atmospheric pressure. Similarly, controlling the turning-off and turning-on of the heater enables reversible switching of the state of the second gastight enclosure 21 (gripping device 20) between the hardened state illustrated in FIG. 12A and the softened state illustrated in FIG. 12B.

As described above, the gas adsorption/desorption device 2 according to the present embodiment supplies energy to the porous medium 12 to release the gas 40 in the porous medium 12 out of the porous medium 12 to soften the second gastight enclosure 21 coupled to the first gastight enclosure 11. On the other hand, the gas adsorption/desorption device 2 stops supplying energy to the porous medium 12 to cause the porous medium 12 to capture the gas 40 in the second gastight enclosure 21 to harden the second gastight enclosure 21.

Specifically, the gas adsorption/desorption device 2 supplies heat energy to the porous medium 12 using the pressurizer/depressurizer 10 formed from the porous medium 12 and the energy producer 13 to increase the pressure inside the second gastight enclosure 21 through desorption of gas adsorbed by the porous medium 12, and to decrease the pressure inside the second gastight enclosure 21 through adsorption of gas with the porous medium 12 with removal of heat energy supplied to the porous medium 12. Thus, the pressure inside the second gastight enclosure 21 can be reduced to a predetermined negative pressure, or the pressure inside the second gastight enclosure 21 can be returned to the atmospheric pressure. Thus, the granules 22 filled in the second gastight enclosure 21 exhibit a solid behavior or a fluid behavior through jamming transition to soften or harden the second gastight enclosure 21. As the second gastight enclosure 21 is thus softened or hardened, the gas adsorption/desorption device 2 can be used as an object gripping device that grips objects.

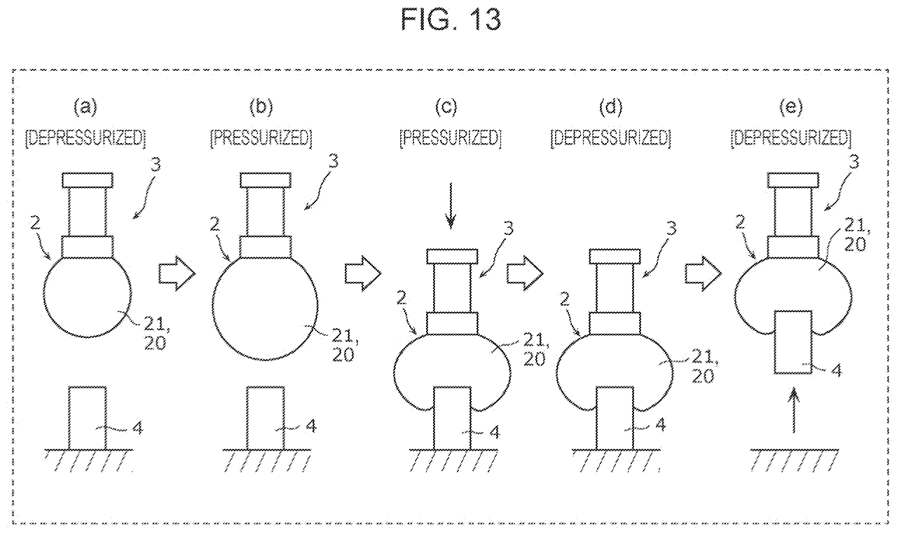

Now, an application example where the gas adsorption/desorption device 2 is used as an object gripping device will be described with reference to FIGS. 12A and 12B. FIG. 13 illustrates the state where a robotic hand 3, to which the gas adsorption/desorption device 2 is applied, grips a workpiece 4. In FIG. 13, the gas adsorption/desorption device 2 is placed while having the gripping device 20 facing vertically downward to face the workpiece 4.

As illustrated in FIG. 13, the robotic hand 3 includes the gas adsorption/desorption device 2 as an object gripping device. The robotic hand 3 can be used as, for example, part of the robotic arm.

In the state illustrated in portion (a) of FIG. 13, the porous medium 12 is supplied with no heat energy, and the pressure inside the second gastight enclosure 21 (a bag in the present embodiment) of the gripping device 20 of the gas adsorption/desorption device 2 is decreased. Thus, the gripping device 20 is in a hardened state.

The heater is turned on to supply heat energy to the porous medium 12 to cause the robotic hand 3 to grip the workpiece 4. Thus, as illustrated in the state in portion (b) of FIG. 13, gas is desorbed from the porous medium 12 to increase the pressure inside the second gastight enclosure 21, so that the second gastight enclosure 21, which is an elastic body, expands. Thus, the gripping device 20 is softened.

Thereafter, as illustrated in the state in portion (c) of FIG. 13, the robotic hand 3 in this state is lowered to press the softened gripping device 20 against the workpiece 4. Thus, the second gastight enclosure 21 is elastically deformed following the shape of the workpiece 4.

Subsequently, as illustrated in the state in portion (d) of FIG. 13, the heater is turned off to remove heat energy supplied to the porous medium 12. Specifically, supply of heat energy to the porous medium 12 is stopped. Thus, the gas in the second gastight enclosure 21 is adsorbed by the porous medium 12 to decrease the pressure inside the second gastight enclosure 21, so that the second gastight enclosure 21 contracts due to elastic resilience. Thus, the gripping device 20 is hardened while having the second gastight enclosure 21 shaped following the shape of the workpiece 4. Specifically, the workpiece 4 is gripped by the hardened gripping device 20.

Thereafter, to move the workpiece 4 gripped by the gripping device 20, for example, as illustrated in the state in portion (e) of FIG. 13, the robotic hand 3 may be raised. Thus, the workpiece 4 can be moved while being held by the gripping device 20.

Although not illustrated, the heater is turned on again to supply heat energy to the porous medium 12 to desorb gas from the porous medium 12. Thus, the pressure inside the second gastight enclosure 21 is increased to soften the second gastight enclosure 21. The workpiece 4 is released from the gripping device 20.

Thus, the robotic hand 3 including the gas adsorption/desorption device 2 can grip or release the workpiece 4.

Subsequently, another application example of the gas adsorption/desorption device 2 used as an object gripping device will be described with reference to FIG. 14. FIG. 14 is a perspective view of a drone 5 according to the embodiment.

As illustrated in FIG. 14, the drone 5 according to the present embodiment includes an object contact portion 5a, which grips or releases an object such as a product, and a controller 5b, which controls the object contact portion 5a to grip or release the object.

The object contact portion 5a includes the gas adsorption/desorption device 2 as an example of the object gripping device. Specifically, the object contact portion 5a includes the gripping device 20 of the gas adsorption/desorption device 2. In other words, the object contact portion 5a includes the gripping device 20 for use as a portion that grips an object by coming into contact with the object or releases the object.

The pressurizer/depressurizer 10 of the gas adsorption/desorption device 2 is installed in the body of the drone 5. Although not illustrated, the pressurizer/depressurizer 10 and the gripping device 20 are coupled with the airway 31.

The drone 5 with such a structure supplies or stops supplying energy to the porous medium 12 of the pressurizer/depressurizer 10 on the basis of a control signal transmitted from the controller 5b, to change the pressure inside the gastight enclosure 100 in the gas adsorption/desorption device 2. Thus, the gripping device 20 of the object contact portion 5a can grip or release the object.

In the present application example, the object contact portion 5a is attached to, for example, a camera 5c included in the drone 5. Thus, the object contact portion 5a can be controlled based on images captured by the camera 5c, so that the object contact portion 5a gripping and releasing an object can be accurately controlled.

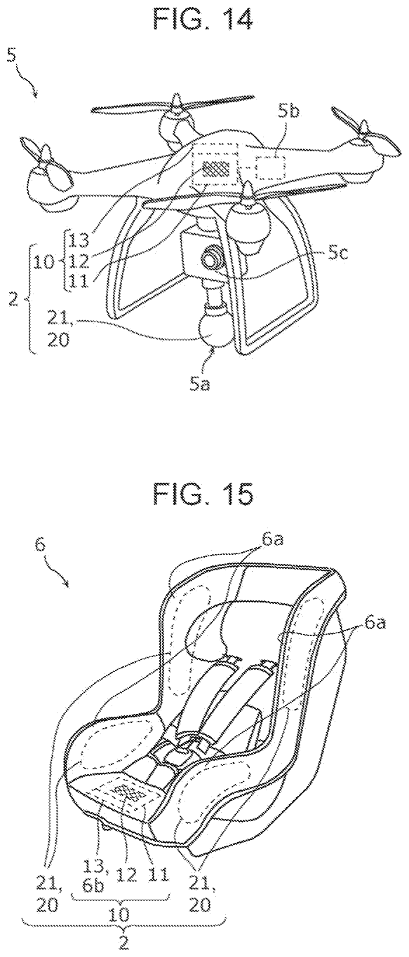

Subsequently, another application example of the gas adsorption/desorption device 2 will be described with reference to FIGS. 15 and 16. FIG. 15 is a perspective view of an infant car seat 6 according to an embodiment. FIG. 16 is a diagram of an assist suit 7 according to an embodiment when worn by a user. The infant car seat 6 illustrated in FIG. 15 and the assist suit 7 illustrated in FIG. 16 are examples of the object securing device that secures the position of an object.

Specifically, the infant car seat 6 illustrated in FIG. 15 is an object securing device that secures the position of an infant, an example of the object, in the infant car seat 6 with the gas adsorption/desorption device 2.

As illustrated in FIG. 15, the infant car seat 6 includes securers 6a, which secure the position of an infant, and an energy supplier 6b, which supplies energy to the porous medium 12, and stops or reduces supply of energy to the porous medium 12.

The securers 6a are side portions located on the sides of the infant seated on the infant car seat 6. In the present embodiment, the securers 6a are located at multiple positions. The securers 6a each include the gas adsorption/desorption device 2 as a device for securing the position of an infant. Specifically, the securers 6a each include the gripping device 20 of the gas adsorption/desorption device 2. Thus, the securers 6a are deformed to lean toward the inner side of the infant car seat 6 or return to the outer side of the infant car seat 6 by using softening or hardening of the gripping device 20. Specifically, the gripping device 20 is hardened to deform the securers 6a to lean toward the inner side of the infant car seat 6 to wrap the infant and secure the position of the infant. On the other hand, the gripping device 20 is softened to deform the securer 6a to expand toward the outer side of the infant car seat 6 to separate the securers 6a from the infant.

The energy supplier 6b serves as the energy producer 13 of the gas adsorption/desorption device 2. Thus, the energy supplier 6b supplies energy to the porous medium 12 of the gas adsorption/desorption device 2, and stops or reduces supply of energy to the porous medium 12. The pressurizer/depressurizer 10 including the energy producer 13 is accommodated in, for example, a bottom seat of the infant car seat 6.

Although not illustrated, the pressurizer/depressurizer 10 and the gripping device 20 are coupled together with the airway 31. The infant car seat 6 may also include a controller that controls the securers 6a.

The infant car seat 6 with this structure causes the energy supplier 6a to supply energy to the porous medium 12, and stop or reduce supply of energy to the porous medium 12. Thus, the infant car seat 6 can secure the position of an infant by changing the pressure inside the gastight enclosure 100 in the gas adsorption/desorption device 2. Specifically, the energy supplier 6b controls gas adsorption/desorption of the porous medium 12 placed in the first gastight enclosure 11 to control the pressure inside the second gastight enclosure 21. Thus, the gripping device 20 can be hardened or softened to secure the position of the infant by wrapping the infant with the securer 6a or to separate the securer 6a from the infant.

An example of the assist suit 7 illustrated in FIG. 16 is a power assist suit that assists an operation or the posture of a person that wears the suit. The assist suit 7 illustrated in FIG. 16 is an object securing device that secures the position of part of the user, which is an object, with the gas adsorption/desorption device 2. FIG. 16 illustrates a construction worker tightening a screw on the ceiling with an automatic screwdriver.

As illustrated in FIG. 16, the assist suit 7 includes securers 7a, which secure part of the body of the user, and an energy supplier 7b, which supplies energy to the porous medium 12, and stops or reduces supply of energy to the porous medium 12.

The securers 7a each include the gas adsorption/desorption device 2 as a device that secures the position of part of the body of the user. Specifically, the securers 7a each include the gripping device 20 of the gas adsorption/desorption device 2. Thus, the securers 7a are deformed to fasten or unfasten the part of the body of the user with softening or hardening of the gripping device 20. Specifically, the gripping device 20 is hardened to fasten part of the body of the user with the securer 7a to secure the position of the part of the body of the user. On the other hand, the gripping device 20 is softened to unfasten the securers 7a.

The securers 7a secure the positions of, for example, user's arms, elbows, trunk, or legs. In the present embodiment, the securers 7a are located at multiple positions. In FIG. 16, the multiple securers 7a secure the positions of the arms and trunk of the worker that performs operations on the ceiling. Specifically, the securers 7a at the arms secure the positions of the worker's arms. The securers 7a at the trunk secure the position of the worker's trunk. Thus, the worker can easily keep the arms raised.

The energy supplier 7b is the energy producer 13 of the gas adsorption/desorption device 2. Thus, the energy supplier 7b supplies energy to the porous medium 12 of the gas adsorption/desorption device 2, and stops or reduces supply of energy to the porous medium 12. The pressurizer/depressurizer 10 including the energy producer 13 is accommodated in, for example, the back of the assist suit 7.

Although not illustrated, the pressurizer/depressurizer 10 and the gripping device 20 are coupled together with the airway 31. The assist suit 7 may also include a controller that controls the securers 7a.

The assist suit 7 with this structure causes the energy supplier 7a to supply energy to the porous medium 12, and stop or reduce supply of energy to the porous medium 12. Thus, the assist suit 7 can secure the position of the object by changing the pressure inside the gastight enclosure 100 in the gas adsorption/desorption device 2. Specifically, the energy supplier 7b controls gas adsorption/desorption of the porous medium 12 placed in the first gastight enclosure 11 to control the pressure inside the second gastight enclosure 21. Thus, the gripping device 20 can be hardened or softened to secure the position of part of the body of the user by fastening the part of the body with the securer 7a or unfasten the part of the body with the securer 7a.

When the gas adsorption/desorption device 2 according to the above embodiment is included in the object securing device, the gas adsorption/desorption device 2 may be applied to products other than the infant car seat 6 and the assist suit 7. For example, the gas adsorption/desorption device 2 may be applied to a seat other than an infant car seat, such as, a booster seat, a car seat, a sofa, or a massager seat. The gas adsorption/desorption device 2 may be applied to a medical device, such as a corset or a cast, as an object securing device that secures the position of part of the human body. The gas adsorption/desorption device 2 is applicable to any of other object securing devices that secure part or entirety of the human body or the position of an object.

As described above, each of the gas adsorption/desorption devices 1, 1A, and 2 according to the embodiments includes the porous medium 12 inside the gastight enclosure 100 or 100A filled with a predetermined gas and supplied with no gas from the outside or releasing no gas to the outside. With supply of energy to the porous medium 12, the predetermined gas in the porous medium 12 is released out of the porous medium 12. By stopping or reducing supply of energy to the porous medium 12, the porous medium 12 captures the predetermined gas inside the gastight enclosure 100 or 100A.

This structure can control the gas adsorption/desorption of the porous medium 12 by simply supplying energy to the porous medium 12, and stopping or reducing supply of energy to the porous medium 12. Thus, the pressure inside the gastight enclosure 100 or 100A can be controlled. Specifically, the pressure inside the gastight enclosure 100 or 100A can be controlled using the gas adsorption/desorption of the porous medium 12 placed in the gastight enclosure 100 or 100A. Thus, the pressure inside the gastight enclosure 100 or 100A can be reduced with a simple structure without involving a vacuum pump, so that the gas adsorption/desorption devices 1, 1A, and 2 can achieve size reduction and weight reduction. Thus, the pressurizing/depressurizing mechanism can achieve size reduction, weight reduction, and independence, and can efficiently increase or decrease the pressure with a simple structure.

In addition, each of the gas adsorption/desorption devices 1, 1A, and 2 according to the embodiments controls the pressure inside the gastight enclosure 100 or 100A with the porous medium 12 and the energy producer 13, and thus has high responsivity to the decrease or increase in pressure inside the gastight enclosure 100 or 100A. Thus, a gas adsorption/desorption device with a small size, light weight, and high responsivity can be achieved.

The gas adsorption/desorption devices 1, 1A, and 2 according to the embodiments increases the pressure inside the gastight enclosure 100 or 100A by supplying energy to the porous medium 12, and decreases the pressure inside the gastight enclosure 100 or 100A by stopping supplying energy to the porous medium 12.

This simple structure can increase or decrease the pressure inside the gastight enclosure 100 or 100A with high responsivity, and thus can efficiently increase or decrease the pressure.

In the gas adsorption/desorption device 1 or 2 according to the present embodiment, the gastight enclosure 100 includes a first gastight enclosure 11, and a second gastight enclosure 21 coupled to the first gastight enclosure 11 through the airway 31. The porous medium 12 is placed in the first gastight enclosure 11.

In this structure, pressure inside the second gastight enclosure 21 serving as a target of pressure change can be controlled with gas adsorption/desorption of the porous medium 12 placed in the first gastight enclosure 11, which is different from the second gastight enclosure 21. Thus, the pressure inside the second gastight enclosure 21 can be more efficiently controlled.

In each of the gas adsorption/desorption devices 1, 1A, and 2 according to the embodiments, the energy producer 13 serves as a heat energy source that supplies heat energy to the porous medium 12. Specifically, energy supplied to the porous medium 12 is heat energy.

In this structure, heat energy supplied to the porous medium 12 is controlled by heating and cooling with the energy producer 13 to control gas adsorption/desorption of the porous medium 12 and control the pressure inside the gastight enclosure 100. Thus, a gas adsorption/desorption device with a simple structure and high responsivity can be achieved.

In each of the gas adsorption/desorption devices 1, 1A, and 2 according to the embodiments, the porous medium 12 may be a metal-organic framework.

This structure can increase the amount of gas adsorption of the porous medium 12. Thus, the degree of change in pressure inside the gastight enclosure 100 or 100A accompanied with gas adsorption/desorption of the porous medium 12 can be increased.

In each of the gas adsorption/desorption devices 1, 1A, and 2 according to the embodiments, the porous medium 12 may be a gate-adsorption metal-organic framework.

In this structure, gas adsorption/desorption occurs at a particular temperature (temperature at which gate opening pressure opens). A gate-adsorption MOF suddenly changes the amount of gas adsorption, and thus responsivity to an increase or decrease of the pressure inside the gastight enclosure 100 or 100A accompanied with adsorption and desorption can be further improved. In addition, gas adsorbed by the porous medium 12 can be completely desorbed easily, so that the efficiency of gas adsorption/desorption with respect to energy supplied to the porous medium 12 can be improved.

In the gas adsorption/desorption devices 1, 1A, and 2 according to the embodiments, the porous medium 12 may be a composite including at least one of inorganic, organic, and metal materials.

In this structure, the energy transfer rate of the porous medium 12 improves, so that the responsivity of the gas adsorption/desorption devices 1, 1A, and 2 can be improved. For example, when heat energy is supplied to the porous medium 12, the porous medium 12 with the above structure improves its heat conductivity, and thus can improve the responsivity to desorption during heating. Thus, the responsivity of the gas adsorption/desorption devices 1, 1A, and 2 can be improved. To form a composite for the porous medium 12, the porous medium 12 preferably has a sparce structure.

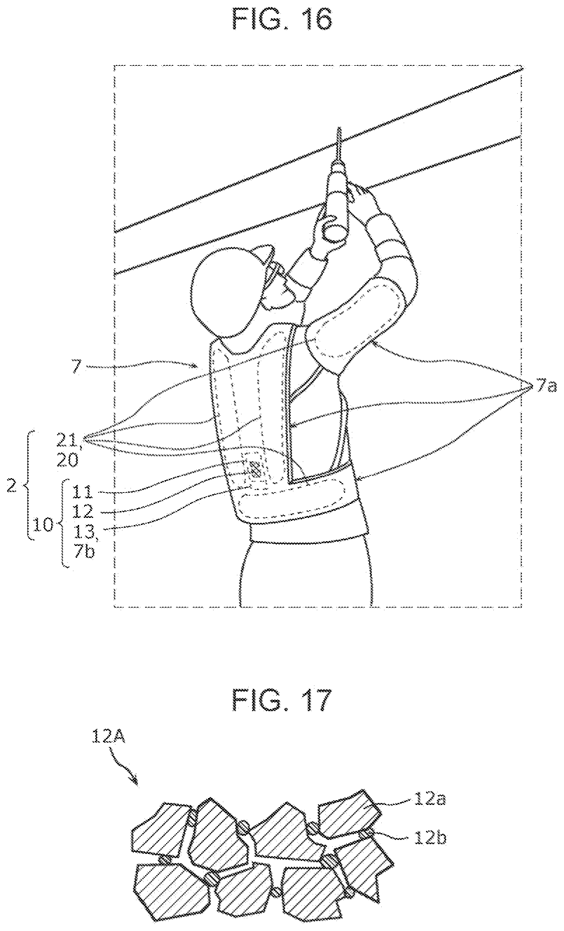

With reference to FIG. 17, an example where the porous medium 12 is formed from a composite will be described. FIG. 17 is a cross-sectional view of a related portion of an example of a composite 12A including porous media 12a and a powder adhesive 12b.

As illustrated in FIG. 17, the composite 12A includes multiple porous media 12a joined together with the powder adhesive 12b. An example usable as the porous media 12a is the porous media 12. Examples usable as the powder adhesive 12b include a dot-application adhesive formed from epoxy resin, phenol resin, acrylic resin, melamine resin, silicone resin, polyethylene, polypropylene, or a denatured resin of any of these. The average particle diameter of the porous media 12a and the average particle diameter of the powder adhesive 12b can be measured by, for example, subjecting the composite 12A to an X-ray computerized tomography (CT).

Although not illustrated, the porous medium 12 may be a composite including a heat conductor. This structure can improve the gas desorption responsivity of the porous medium 12 during heating. This point will be described, below.

To desorb gas from the porous medium 12 that has adsorbed gas with heat energy, an amount of heat taken for desorption has to be transmitted to the porous medium 12. Here, gas desorption responsivity depends on the heat transfer speed to the porous medium 12. A single unit of the porous medium 12 such as a MOF generally has low thermal conductivity. Thus, heat energy supplied to the porous medium 12 by the energy producer 13 slowly transfers to the inside of the porous medium 12. The single unit of the porous medium 12 thus has a low response speed to gas adsorption/desorption. To address this, the porous medium 12 is composited with a thermal conductor with relatively high thermal conductivity, so that the composite of the porous medium 12 and the thermal conductor has high thermal conductivity. In this way, gas desorption responsivity during heating can be improved. Thus, the speed of pressurizing the gastight enclosure 100 (second gastight enclosure 21) can be improved.

A thermal conductor composited with the porous medium 12 is not limited to a particular one. Examples of a thermal conductor include carbon materials, such as graphite, and metal materials. The thermal conductor may be selected as appropriate in accordance with the porous medium 12 used. The material of the thermal conductor is not limited to a particular one, and may be any that does not hinder adsorption of the porous medium 12. The method of compositing the porous medium 12 and the thermal conductor and a specific structure of the composite are not limited to particular ones.

In each of the gas adsorption/desorption device 1 or 2 according to the present embodiment, the first gastight enclosure 11 and the second gastight enclosure 21 are separate with the airway 31 interposed therebetween.

In this structure, the second gastight enclosure 21 that is separate from the first gastight enclosure 11 can control the pressure inside the second gastight enclosure 21. Thus, the structure can be easily developed for various uses involving high responsivity.

In the gas adsorption/desorption device 2, the pressurizer/depressurizer 10 may not be separate from the gripping device 20, and part or whole of the pressurizer/depressurizer 10 may be inside the gripping device 20. For example, the porous medium 12 may be disposed inside the second gastight enclosure 21. Here, the energy producer 13 is preferably installed outside of the second gastight enclosure 21, but may be installed inside the second gastight enclosure 21. By thus installing part or whole of the pressurizer/depressurizer 10 inside the gripping device 20, part or whole of the pressurizer/depressurizer 10 can be integrated with the gripping device 20, and part or whole of the pressurizer/depressurizer 10 does not have to be installed separate from the gripping device 20. Thus, the gas adsorption/desorption device 2 has a simpler structure.

In the gas adsorption/desorption device 2 according to the present embodiment, the controlling device 31a that controls flow of gas passing through the airway 31 is installed at the airway 31.

In this structure, the controlling device 31a can control flow of gas adsorbed and desorbed by the porous medium 12, so that the pressure inside the second gastight enclosure 21 can be easily adjusted, and more freely. For example, when the controlling device 31a is a cock, the porous medium 12 is heated while the cock is closed to desorb gas in advance, and then the cock is opened to flow gas to the second gastight enclosure 21 to increase the pressure inside the second gastight enclosure 21. In other words, controlling opening and closing of the cock controls timing of pressurizing and depressurizing the second gastight enclosure 21. The controlling device 31a may be installed at the gas adsorption/desorption device 1 illustrated in FIG. 1.

In each of the gas adsorption/desorption devices 1, 1A, and 2 according to the embodiments, a dehumidifier may be placed in the gastight enclosure 100 or 100A in which the porous medium 12 is placed. An example of the dehumidifier is silica gel. In the gas adsorption/desorption device 1 or 2, the dehumidifier is disposed in, for example, the first gastight enclosure 11 in which the porous medium 12 is placed.

The dehumidifier thus disposed can prevent the porous medium 12 from absorbing moisture, and thus can prevent deterioration of the porous medium 12. This structure can thus keep the performance of the porous medium 12 for a long term. Thus, a reliable gas adsorption/desorption device can be achieved.

### Modification 1

Subsequently, a gas adsorption/desorption device according to modification 1 will be described.

A gas adsorption/desorption device according to the present modification has a structure obtained by replacing, with a light energy source, the heat energy source serving as the energy producer 13 in the gas adsorption/desorption device according to the above embodiment. Specifically, in the present modification, energy supplied to the porous medium 12 is light energy.

In the gas adsorption/desorption device 1 according to the embodiment, the gas adsorption/desorption of the porous medium 12 is controlled using a heat energy source as the energy producer 13. When gas adsorption/desorption of the porous medium 12 is controlled with heat energy, the pressurizing and depressurizing response speeds inside the gastight enclosure 100 are dominated by heating speed and cooling speed. Additionally installing a cooling mechanism to increase the cooling speed increases the size of the gas adsorption/desorption device 1.

In the present modification, a light energy source is used as the energy producer 13. An example of the energy producer 13 is a light generator that generates light that supplies light energy to the porous medium 12. Using the light energy source as the energy producer 13 enables control of gas adsorption/desorption of the porous medium 12 with light energy.

Thus, the porous medium 12 according to the present modification is supplied with light energy to perform gas adsorption/desorption. For example, the porous medium 12 according to the present modification has a mechanism for desorbing adsorbed gas molecules with light irradiation. The porous medium 12 is not limited to a particular one, but for example, may be in the form of introducing photoresponsive molecules into porous medium 12, or in the form of a composite of metal nanoparticles having photothermal effect with the porous medium 12 (Haiquing Li et al., ACC. Chem Res., 2017, 50, 778. (Non-patent Literature 3)). These forms will be specifically described below.

Photoresponsive molecules are macromolecules that change their molecular structure when irradiated with light. Examples of changes of the molecular structure include cis-trans isomerization due to light irradiation of carbon-carbon double bonds or nitrogen-nitrogen double bonds of unsaturated alkene or azobenzenes, and ring-opening/ring-closure reaction due to light irradiation of a ring structure of, for example, diarylethenes, spiropyrans, or fulgides.

As examples of the way to introduce the photoresponsive molecules into the porous medium 12 and the form of structure, the photoresponsive molecules may be introduced inside the pores of the porous medium 12 as guest molecules, or introduced as a frame of the porous medium 12.

In the above structure, an example where an amount of adsorption of the porous medium 12 changes before and after light irradiation has been reported. The mechanism of the change is not completely clarified, but is assumed as followed.

As to the structure where photoresponsive molecules are introduced inside the pores of the porous medium as guest molecules, the following mechanism is proposed: when photoresponsive molecules change their structure due to light irradiation, the latent potential on the surface of the pores of the porous medium 12 changes, so that the amount of adsorption changes.

As to the structure where photoresponsive molecules are introduced as a frame of the porous medium 12, the following mechanisms are proposed: the structure change of photoresponsive molecules due to light irradiation changes the latent potential on the surfaces of the pores of the porous medium 12 to thus change the amount of adsorption, and a dynamic change of the frame structure changes the capacity of the pores to thus change the amount of adsorption.

For example, a MOF expressed in chemical formula of Zn(AzDC)(bpe)_{0.5} can be used as the porous medium 12 that is supplied with light energy to adsorb or desorb gas. Here, AzDC denotes azobenzene-4,4′-dicarboxylic acid, and bpe denotes trans-1,2-bis(4-pyridyl)ethylene. In the MOF, AzDC and bpe are isomerized by being irradiated with ultraviolet (UV) light. When the MOF that has adsorbed gas is irradiated with UV light, gas can be desorbed from the MOF. Specifically, the amount of CO₂ adsorbed before UV light irradiation was 5.1 wt % (under atmospheric pressure at 30° C.), and the amount of CO₂ adsorbed after UV light irradiation was 2.8 wt % (under atmospheric pressure at 30° C.).

Another structure of the porous medium 12 including photoresponsive molecules includes a composite of the porous medium 12 and metal nanoparticles having a photothermal effect.

The photothermal effect is a phenomenon where light energy is converted into heat energy. For example, it is known that, when metal nanoparticles such as gold or silver are irradiated with light, heat energy occurs on the surface of nanoparticles due to the plasmon resonance effect.

When metal nanoparticles and the porous medium 12 are composited, metal nanoparticles cause heat in response to light irradiation. Thus, heat can be locally transferred to the porous medium 12. Gas adsorbed by the porous medium 12 is thus released from the porous medium 12.

For example, another example usable as the porous medium 12 that adsorbs and desorbs gas in response to supply of light energy is a composite of Ag nanoparticles and UiO-66. UiO-66 is expressed with a chemical formula of Zr₆O₄(OH)₄(bdc)₆, where bdc denotes a terephthalic acid. When the composite that has adsorbed gas is irradiated with visible light, gas can be desorbed from the composite. Specifically, the amount of CO₂ adsorbed before visible light irradiation was 5 wt % (under atmospheric pressure at 25° C.), and the amount of CO₂ adsorbed after visible light irradiation was 1 wt % (under atmospheric pressure at 25° C.).

For the method of compositing metal nanoparticles and the porous medium 12 and a specific structure of the composite of metal nanoparticles and the porous medium 12, metal nanoparticles may be selected as appropriate in accordance with the porous medium 12 used. As long as the porous medium 12 is prevented from impairing its adsorption performance, the composition method and the composite structure may be any.

As an example of a light irradiator of the energy producer 13 according to the present modification, a device obtained by coupling a small motor to a small light source such as a LED may be installed on the first gastight enclosure 11 in which the porous medium 12 is placed. As long as allowing the porous medium 12 to adsorb and desorb a specific amount of gas used for a predetermined pressure change, the light irradiator may be any irradiator. The wavelength, intensity, irradiation time of light may be determined as appropriate in accordance with the porous medium 12 and the type of the composite, the capacity of the target of pressure change, and the usable pressure range of the target of pressure change.

In the gas adsorption/desorption device according to the present modification including a light energy source as the energy producer 13, the porous medium 12 adsorbs gas to decrease the pressure without light irradiation, and the porous medium 12 desorbs gas to increase the pressure with light irradiation. Thus, the present modification can control adsorption and desorption of the porous medium 12 by turning a switch on or off, and achieves a gas adsorption/desorption device with high responsivity to pressurization and depressurization with a simple structure.

### Modification 2

Subsequently, a gas adsorption/desorption device according to modification 2 will be described.

The gas adsorption/desorption device according to the present modification has a structure obtained by replacing, with a magnetic energy source, the heat energy source serving as the energy producer 13 of the gas adsorption/desorption device according to the above embodiment. In the present modification, energy supplied to the porous medium 12 is magnetic energy.

In the gas adsorption/desorption device according to the modification, a light energy source is used as the energy producer 13 to control gas adsorption/desorption of the porous medium 12. When gas adsorption/desorption of the porous medium 12 is controlled with light energy, light may fail to reach the inside of the porous medium 12. Thus, light irradiation may fail to cause effective gas adsorption or desorption, so that a desired pressurization or depressurization control may be failed.

On the other hand, the magnetic field basically passes through objects. Thus, as in the gas adsorption/desorption device according to the present modification, by generating a magnetic field in a space where the porous medium 12 is placed using a magnetic energy source as the energy producer 13, gas adsorption/desorption of the porous medium 12 can be effectively performed. For example, a magnetic force generator that generates magnetic force supplying magnetic energy to the porous medium 12 may be used as the energy producer 13. By thus using the magnetic energy source as the energy producer 13, gas adsorption/desorption of the porous medium 12 can be controlled by the magnetic energy. Specifically, when the porous medium 12 that has adsorbed gas is irradiated with the magnetic field, gas is desorbed.

Thus, the porous medium 12 according to the present modification adsorbs and desorbs gas in response to supply of magnetic energy. For example, the porous medium 12 according to the present modification includes a mechanism for desorbing adsorbed gas with supply of magnetic energy. The porous medium 12 is not limited to a particular one. An example of a form is a composite of the porous medium and a material that generates heat with supply of magnetic energy. A specific form will be described, below.

Examples of a material that generates heat with supply of magnetic energy include thermal metal nanoparticles such as iron oxide nanoparticles including Fe₃O₄ and MgFe₂O₄(Non-patent Literature 3). It is known that, when a high-frequency magnetic field is applied to iron oxide nanoparticles, hysteresis loss occurs and heat is generated.

Thus, in the composite of iron oxide nanoparticles and the porous medium, iron oxide nanoparticles generate heat in response to application of the magnetic field, so that heat is locally transferred to the porous medium. Thus, gas adsorbed by the porous medium 12 is released from the porous medium 12.

For the method of compositing iron oxide nanoparticles and the porous medium and a specific structure of the composite of iron oxide nanoparticles and the porous medium, iron oxide nanoparticles may be selected as appropriate in accordance with the porous medium used. As long as the porous medium 12 is prevented from impairing its adsorption performance, the composition method and the composite structure may be any.

As an example of a magnetic-field applicator of the energy producer 13 according to the present modification, a device obtained by coupling a small motor to an AC magnetic-field generator such as a coil may be installed on the first gastight enclosure 11 in which the porous medium 12 is placed. Alternatively, a coil may be wound around the entire portion where the porous medium 12 is installed. As long as allowing the porous medium 12 to adsorb and desorb a specific amount of gas used for a predetermined pressure change, the magnetic-field applicator may be any. The magnetic flux density, the direction of magnetic flux, the time of magnetic field application of the magnetic field applied may be determined as appropriate in accordance with the porous medium 12 and the type of the composite, the capacity of the target of pressure change, and the usable pressure range of the target of pressure change.

Examples of the porous medium 12 that adsorbs or desorbs gas without or with supply of magnetic energy include a composite of Fe₃O₄ nanoparticles and Mg-MOF-74. When the composite that has adsorbed gas receives a magnetic field, the composite desorbs gas. Specifically, the amount of CO₂ adsorbed before AC magnetic-field application was 30.8 wt % (under atmospheric pressure at 25° C.), and the amount of CO₂ adsorbed after AC magnetic-field application was 13.9 wt % (under atmospheric pressure at 25° C.).

In the gas adsorption/desorption device according to the present modification including a magnetic energy source as the energy producer 13, the porous medium 12 adsorbs gas to decrease the pressure without magnetic field application, and the porous medium 12 desorbs gas to increase the pressure with magnetic field application. Thus, the present modification can control adsorption and desorption of the porous medium 12 by turning a switch on or off, and achieves a gas adsorption/desorption device with high responsivity of pressurization and depressurization with a simple structure.

### Other Modifications

Thus far, the gas adsorption/desorption device and the object gripping device according to some embodiments and modifications of the disclosure have been described. However, the disclosure is not limited to the above embodiments.

For example, in the gas adsorption/desorption device and the object gripping devices according to the embodiments, CO₂ is described as an example of gas adsorbed and desorbed by the porous medium 12, but this is not the only possible example. Examples of gas adsorbed and desorbed by the porous medium 12 include N₂, O₂, CH₄, C₂He, C₂H₂, NH₃, and H₂ other than CO₂.

In the object gripping device according to the embodiment, granules 22 are described as an example of a substance that changes its state by jamming transition, but this is not the only possible example. Examples of a substance that changes its state by jamming transition include fiber such as inorganic or organic fiber and a laminate of films or sheets. Specifically, an object accommodated in the second gastight enclosure 21 may be any substance that changes its state by jamming transition.

Forms obtained by subjecting the embodiments and the modifications to various changes that persons having ordinary skill in the art can conceive, and forms obtained by combining components and functions of the embodiments and the modifications without departing from the gist of the present disclosure are also included in the present disclosure.

The gas adsorption/desorption device according to one or more embodiments of the disclosure is applicable to any device that involves pressure control, such as an object gripping device including a robotic hand using jamming transition.

What is claimed is:

1. A gas adsorption/desorption device, comprising:
a gastight enclosure filled with a predetermined gas and supplied with no gas from outside or releasing no gas to the outside; and
a porous medium disposed in the gastight enclosure, wherein
the predetermined gas in the porous medium is released out of the porous medium in response to supply of energy to the porous medium, and
the porous medium captures the predetermined gas in the gastight enclosure in response to stopping or reducing of the supply of the energy to the porous medium.

2. The gas adsorption/desorption device according to claim 1, wherein
the gastight enclosure includes a first gastight enclosure and a second gastight enclosure coupled to the first gastight enclosure through an airway, and
the porous medium is disposed inside the first gastight enclosure.

3. The gas adsorption/desorption device according to claim 1,
wherein a pressure in the gastight enclosure rises in response to the supply of the energy to the porous medium, and
wherein the pressure in the gastight enclosure lowers in response to stopping of the supply of the energy to the porous medium.

4. The gas adsorption/desorption device according to claim 1, wherein the porous medium is a metal-organic framework.

5. The gas adsorption/desorption device according to claim 4, wherein the metal-organic framework is a gate-adsorption metal-organic framework.

6. The gas adsorption/desorption device according to claim 1, wherein the porous medium is a composite including at least one selected from the group consisting of an inorganic material, an organic material, and a metal.

7. The gas adsorption/desorption device according to claim 1, wherein the energy is heat energy.

8. The gas adsorption/desorption device according to claim 1, wherein the energy is light energy.

9. The gas adsorption/desorption device according to claim 1, wherein the energy is magnetic energy.

10. An object securing device, comprising:
a securer including the gas adsorption/desorption device according to claim 1, the securer securing a position of an object; and
an energy supplier that supplies energy to the porous medium, or stops or reduces supply of energy to the porous medium,
wherein when the energy supplier supplies the energy to the porous medium, or stops or reduces the supply of the energy to the porous medium, a pressure in the gastight enclosure in the gas adsorption/desorption device changes to secure the position of the object.

11. A drone, comprising:
an object contact portion that grips an object or releases the object; and
a controller that controls the object contact portion to grip or release the object, wherein
the object contact portion includes the gas adsorption/desorption device according to claim 1, and,
in response to a control signal transmitted from the controller, supply of energy to the porous medium is started, stopped, or reduced to change a pressure in the gastight enclosure in the gas adsorption/desorption device.

12. A pressure control method using a gastight enclosure and a porous medium, the gastight enclosure being filled with a predetermined gas and being supplied with no gas from outside or releasing no gas to the outside, the porous medium being disposed in the gastight enclosure, the method comprising:
pressurizing the gastight enclosure by releasing the predetermined gas in the porous medium out of the porous medium in response to supply of energy to the porous medium; and
depressurizing the gastight enclosure by capturing the predetermined gas in the gastight enclosure with the porous medium in response to stopping or reducing of supply of energy to the porous medium.

13. The pressure control method according to claim 12, wherein
the gastight enclosure includes a first gastight enclosure and a second gastight enclosure coupled to the first gastight enclosure,
the porous medium is disposed in the first gastight enclosure, and
the second gastight enclosure is pressurized or depressurized by desorbing the predetermined gas from the porous medium or adsorbing the predetermined gas with the porous medium.

14. The pressure control method according to claim 13,
wherein the second gastight enclosure is formed from an elastically deformable material.

15. The pressure control method according to claim 12,
wherein the porous medium is subjected to treatment to be capable of adsorbing the predetermined gas before being placed in the first gastight enclosure.

16. The pressure control method according to claim 12,
wherein the porous medium is a metal-organic framework.

17. The pressure control method according to claim 16,
wherein the metal-organic framework is a gate-adsorption metal-organic framework.

18. An object gripping method performed by using a first gastight enclosure, a porous medium, and a second gastight enclosure, the first gastight enclosure being filled with a predetermined gas and being supplied with no gas from outside or releasing no gas to the outside, the porous medium being disposed in the first gastight enclosure, the second gastight enclosure being coupled to the first gastight enclosure, the method comprising:
softening the second gastight enclosure by supplying energy to the porous medium to release the predetermined gas in the porous medium out of the porous medium, and
hardening the second gastight enclosure by stopping or reducing of supply of the energy to the porous medium to capture the predetermined gas in the second gastight enclosure with the porous medium.

19. The object gripping method according to claim 18, wherein the second gastight enclosure is formed from an elastically deformable material.

20. The object gripping method according to claim 18,
wherein softening the second gastight enclosure includes
blocking flow of gas between the first gastight enclosure and the second gastight enclosure to desorb gas from the porous medium, and
thereafter, flowing gas between the first gastight enclosure and the second gastight enclosure to pressurize the second gastight enclosure, and
wherein hardening the second gastight enclosure includes
blocking flow of gas between the first gastight enclosure and the second gastight enclosure to cause the porous medium to adsorb gas, and
thereafter, flowing gas between the first gastight enclosure and the second gastight enclosure to depressurize the second gastight enclosure.
